(19) United States
(12) Patent Application Publication
(10) Pub. No.: US 2025/0047753 A1
(43) Pub. Date: Feb. 6, 2025

(54) SYSTEMS AND METHODS FOR USER-GENERATED ENTERTAINMENT

(71) Applicant: Twenty Four 7, Inc., Portland, OR (US)

(72) Inventor: Michelle Lettunich, Portland, OR (US)

(21) Appl. No.: 18/793,659

(22) Filed: Aug. 2, 2024

Related U.S. Application Data
(60) Provisional application No. 63/517,573, filed on Aug. 3, 2023.

(51) Int. Cl. H04L 67/306; G06Q 30/0208; G06Q 30/0601; G06Q 50/00

(52) U.S. Cl. CPC H04L 67/306; G06Q 30/0208; G06Q 30/0631; G06Q 50/01

(57) ABSTRACT

Herein disclosed are systems and methods for providing personalized entertainment to users of a social platform based on user input. In one example, a computer-implemented method comprising: providing a user interface by a social platform to generate personalized entertainment content, the social platform comprising a plurality of user accounts, a user interest system, and a marketplace system, the user interest system comprising one or more modules configured to present a plurality of input controls for generating one or more user interests by the social platform. The method includes receiving user input from a user associated with a user account via the plurality of input controls. The method includes generating a user interest based on the user input, storing the user interest in a database, and displaying the user interest on the social platform.

### CROSS REFERENCE TO RELATED APPLICATIONS

The present application claims priority to U.S. Provisional Application No. 63/517,573 entitled SYSTEMS AND METHODS FOR USER-GENERATED ENTERTAINMENT filed Aug. 3, 2023. The entire content of the above application is hereby incorporated by reference for all purposes.

### FIELD

The present application relates to systems and methods for generating personalized entertainment for users of a social platform based on user input.

### BACKGROUND AND SUMMARY

Conventional electronic gaming platforms, such as mobile apps and PC-game communities, suffer because they fail to provide users with variety and customization, and when such platforms provide variety and customization, they frequently target experienced gamers and fail to capture a more general audience. One reason for this challenge is that electronic gaming platforms do little to engage users to create personalized entertainment content, such as avatars, friend communities, original games, and marketplaces. Another factor limiting the success of electronic gaming platforms is that when they do encourage personalization, the platforms may lack simple processes and easy-to-follow user interfaces for generating personalized entertainment content, again, potentially losing the general audience.

One approach to increase use of gaming platforms is to provide rewards for playing games, as well as engage users to create their own games and competitions. However, rewards are frequently limited to the electronic gaming platform environment, such as badge-like items and increased access to games, or are earned through real cash purchases. Further, gaming platforms with limited personalization features may miss opportunities to tailor rewards to platform users. As a result, opportunities to engage outside merchants and potential sponsors of the gaming platform with valuable user preference information are diminished.

Having identified the aforementioned challenges, the inventors herein have developed systems and methods that enable personalized entertainment generation for users of a social platform based on user input, such as, but not limited to, multiplayer games and games originated by brand partners and other users. In one example, a computer-implemented method comprising: providing a user interface by a social platform to generate personalized entertainment content, the social platform comprising a plurality of user accounts, a user interest system, and a marketplace system, the user interest system comprising one or more modules configured to present a plurality of input controls for generating one or more user interests by the social platform. The method includes receiving user input from a user associated with a user account via the plurality of input controls. The method includes generating a user interest based on the user input, storing the user interest in a database, and displaying the user interest on the social platform.

The systems and methods lower the barrier to entry in platform experience customization, thereby encouraging participation across a wider range of potential users from experienced gamers to novices. As a result, relationships are established between brands and user groups to enable brand partners effective message delivery.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE DRAWINGS

FIG. 1A shows an example of a social platform.

FIG. 1B shows an example of a computing system implementing the social platform.

FIG. 2A shows an example marketplace system of the social platform.

FIG. 2B shows an example user interest system of the social platform.

FIG. 3 shows a high level flowchart of a method for creating an avatar on the social platform.

FIG. 4 shows a high level flowchart of a method for game categorization and suggestion on the social platform.

FIG. 5 shows a high level flowchart of a method for creating game metadata on the social platform.

FIG. 6 shows a high level flowchart of a method for creating a fantasy sports league on the social platform.

FIG. 7 shows a high level flowchart of a method for generating game cover art on the social platform.

FIG. 8 shows examples of graphical user interfaces for generating an avatar on the social platform.

FIG. 9A shows an example control panel interface for creating and adding tags for game categorization on the social platform.

FIG. 9B shows an example control panel interface for updating tags for game categorization on the social platform.

FIG. 9C shows a first example of a control panel interface for handling of metadata associated with a user-generated game on the social platform.

FIG. 9D shows a second example of a control panel interface for backend handling of metadata associated with a user-generated game on the social platform.

FIG. 9E shows an example of a game catalogue API for a user-generated game on the social platform.

FIG. 10 shows examples of graphical user interfaces for creating a game on the social platform.

FIG. 11A shows examples of graphical user interfaces for creating a fantasy football team on the social platform.

FIG. 11B shows further examples of graphical user interfaces for creating a fantasy football team on the social platform.

FIG. 11C shows additional examples of graphical user interfaces for creating a fantasy football team on the social platform.

FIG. 12 shows examples of graphical user interfaces for generating, displaying, and accessing personalized entertainment on the social platform.

FIG. 13 shows an example of a graphical user interface for creating a multiplayer game on the social platform.

FIG. 14 shows an example of a graphical user interface for accessing a marketplace displaying products and entertainment content affiliated with a merchant on the social platform.

FIG. 15 shows an example graphical user interface for a tiebreaker.

### DETAILED DESCRIPTION

The following description relates to systems and methods for a social platform providing personalized entertainment and rewards to users based on user input. The social platform may comprise a website or other digital environment where users display and interact with personalized entertainment and earn rewards. Personalized entertainment may comprise user interests, such as games, challenges, competitions, trophies, and social platform-based communities, including, for example, customizable and user-generated art, original games, and avatars. Rewards may comprise currency and/or access keys that may be used in a marketplace; however, users may also earn rewards for items that are not for purchase, such as, for example, digital goods, hard goods, or services. In a few examples, the marketplace may comprise custom avatar pieces, sponsor-related products, experiences, digital goods, and hard goods. Marketplace goods may be sourced by platform administrators, offered by participating merchants (e.g., businesses, sponsors), and/or offered by platform users, including, for example, customizable and user-generated products. Marketplace goods may be acquired at auction and/or available purchase using digital currency and/or real currency. Rewards may be user-tailored in personalized marketplaces based on social platform interaction and user interests.

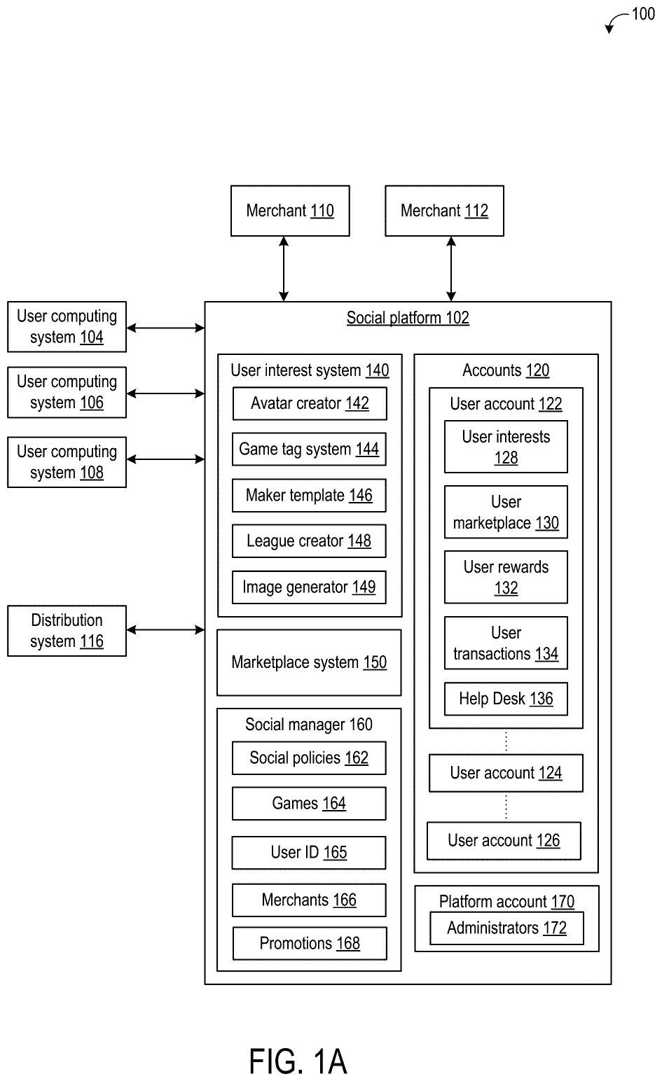

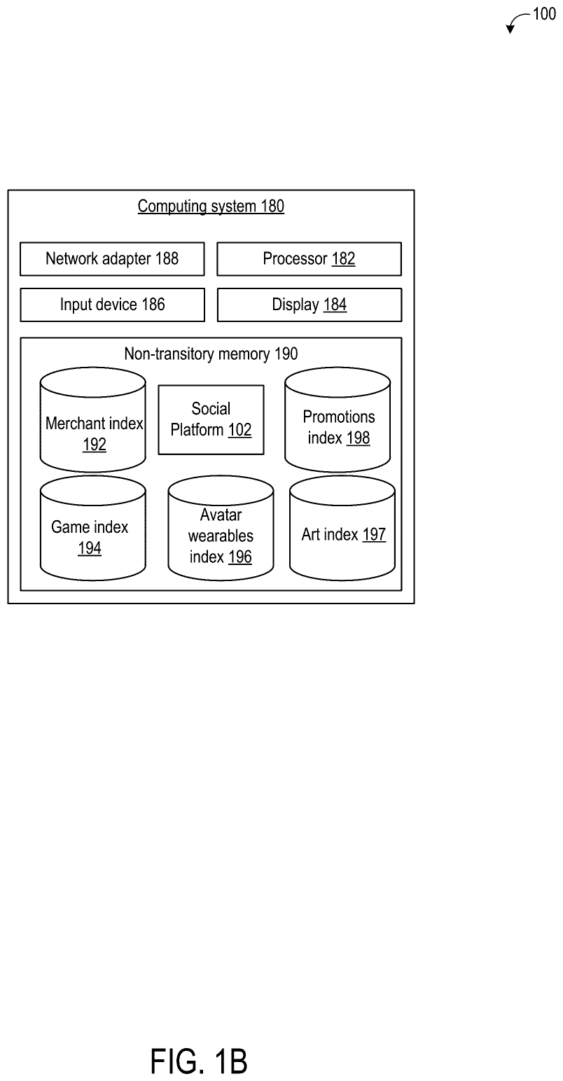

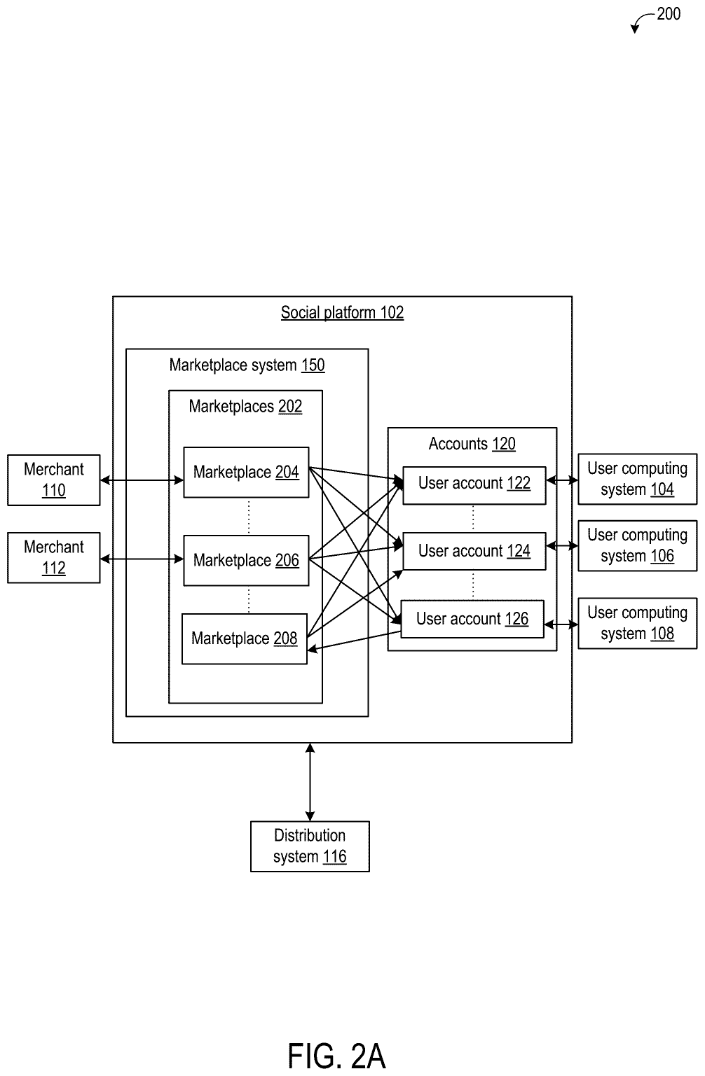

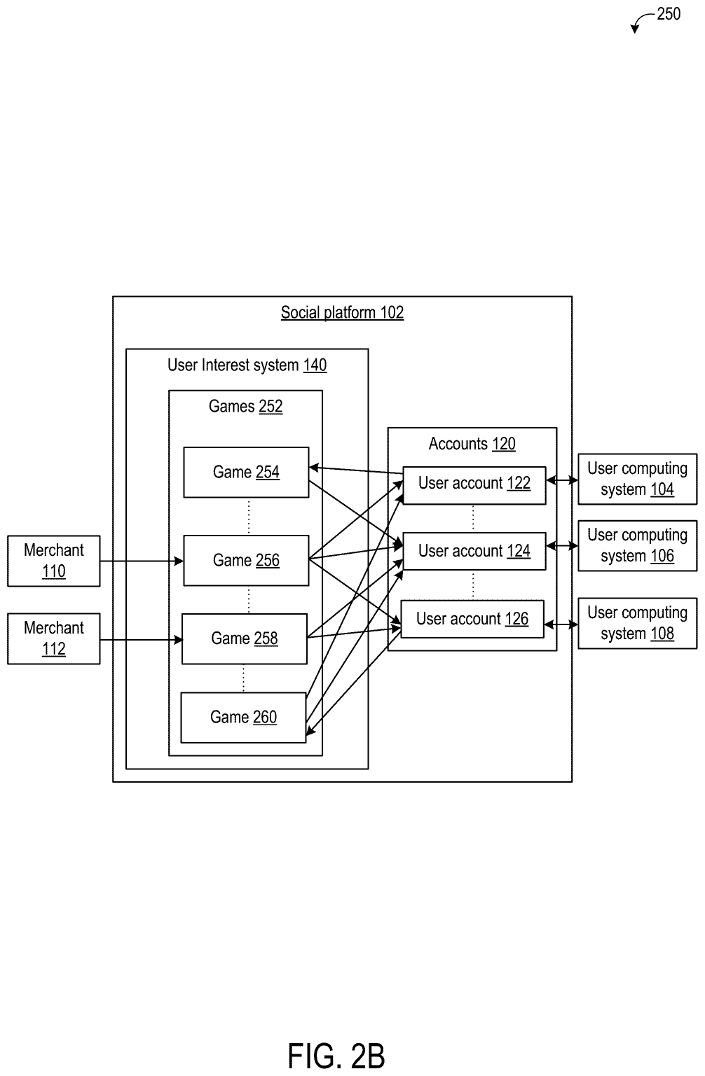

The following description provides examples of systems and methods that may enable a social platform, such as social platform 102 shown in FIG. 1A, to provide personalized entertainment and rewards to platform users while reducing a complexity of generating such content, and encouraging engagement with the social platform by a broad audience. The social platform may be implemented by one or more computing systems, such as computing system 180 shown in FIG. 1B. Computing system 180 may include non-transitory memory, which may include instructions that when executed carry out one or more steps of one or more of the methods herein disclosed, such as a method 300, a method 400, a method 500, a method 600, and a method 700 discussed in detail below. It will be understood that social platforms, such as social platform 102, may be implemented by more than one computing system, such as in a distributed computing scheme, wherein various functionalities of the social platform may be enabled by a plurality of networked computing systems working in concert. Social platform 102 may comprise a marketplace system, such as marketplace system 150 shown in FIG. 1A and FIG. 2A, which may display rewards that are available for purchase or at auction using, for example, points, credit, or real currency. In some examples, the marketplace system may comprise a plurality of user marketplaces, each user marketplace based on an individual user's interaction with the social platform and displayed in a user marketplace tied to the account of the user. Social platform 102 may comprise a user interest system, such as a user interest system 140 shown in FIG. 1A and FIG. 2B, optionally comprising one or more tools for creating, displaying, and interacting with personalized entertainment that is accessible through the user's account.

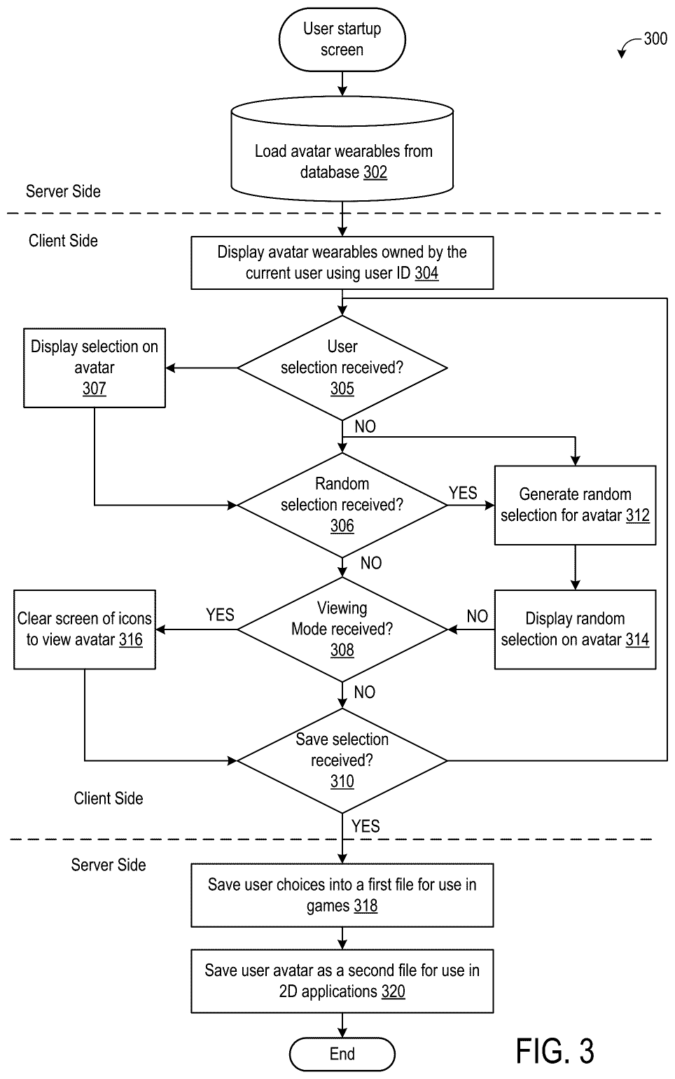

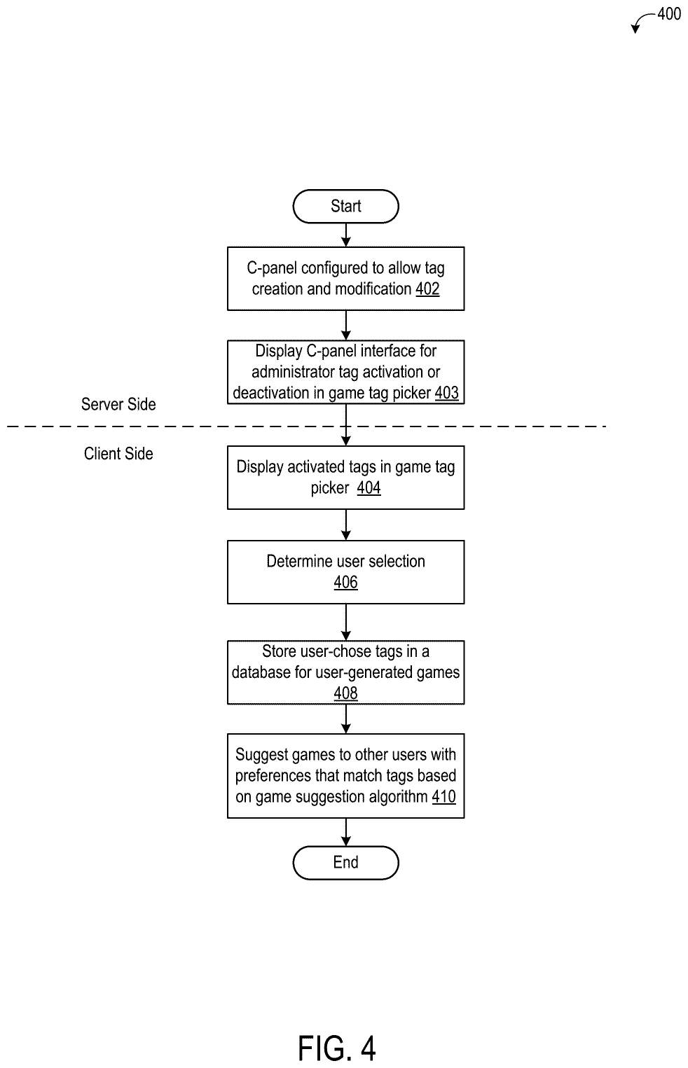

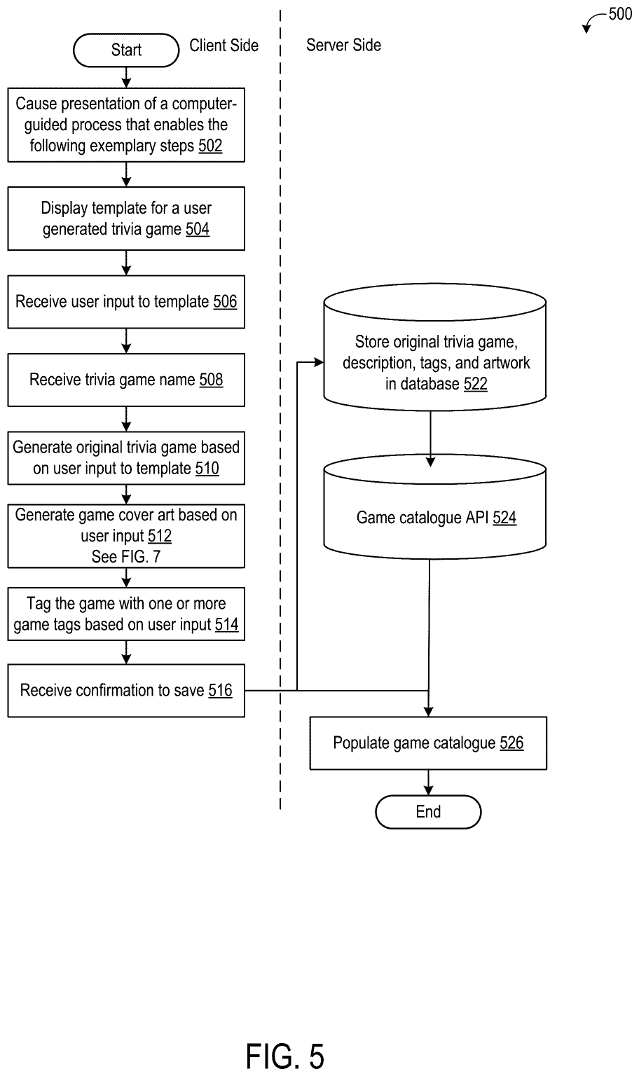

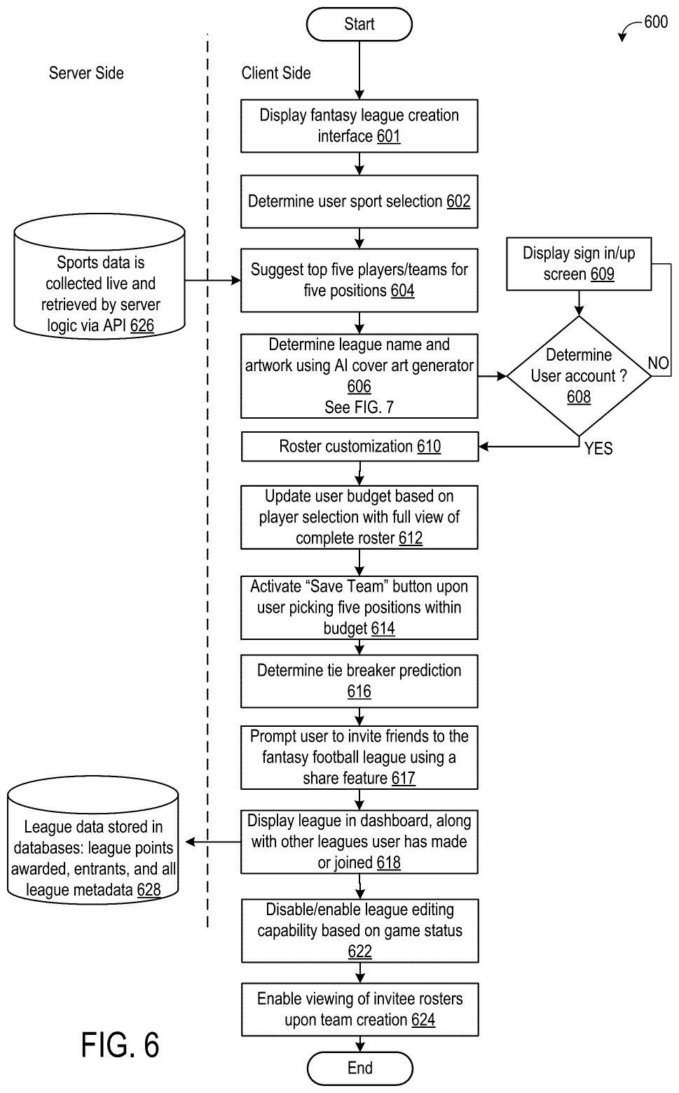

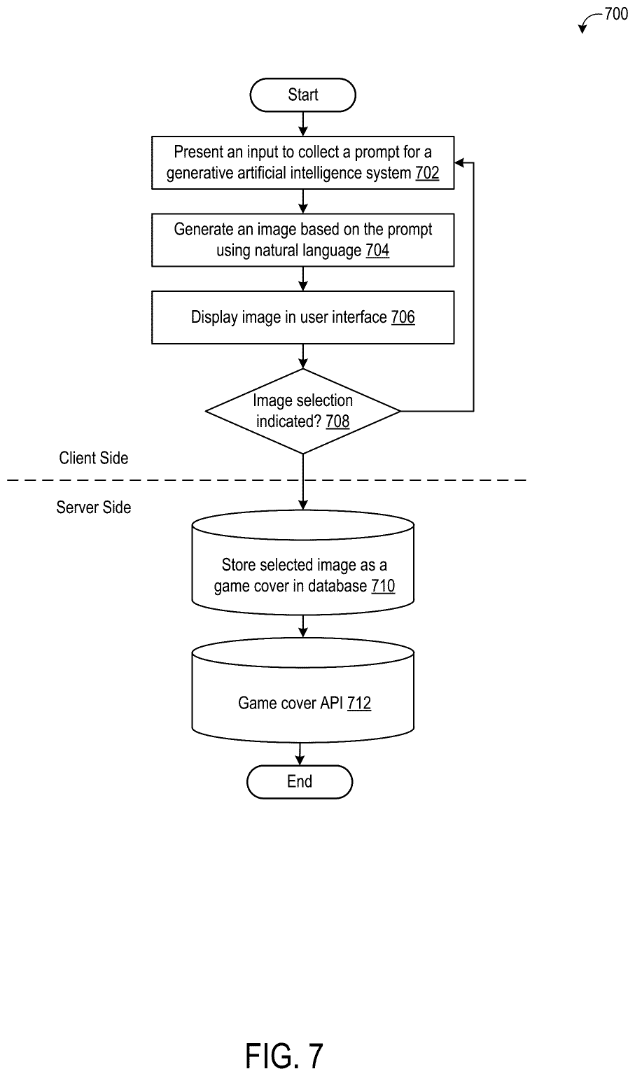

In a few examples, the user interest system may include a tool for creating a digital representation or avatar according to a method, such as the method 300 shown in FIG. 3. The user interest system may include a tool for categorizing user-generated games to personalize content delivery and suggestions according to a method, such as the method 400 shown in FIG. 4. FIG. 5 shows one example of a method (e.g., the method 500) by which the user interest system may enable users to create game metadata for user-generated games. FIG. 6 shows an example method (e.g., the method 600) by which the user interest system may enable users to create a fantasy sports league. FIG. 7 shows an example method (e.g., the method 700) by which the user interest system may enable users to create custom cover art for user-generated games.

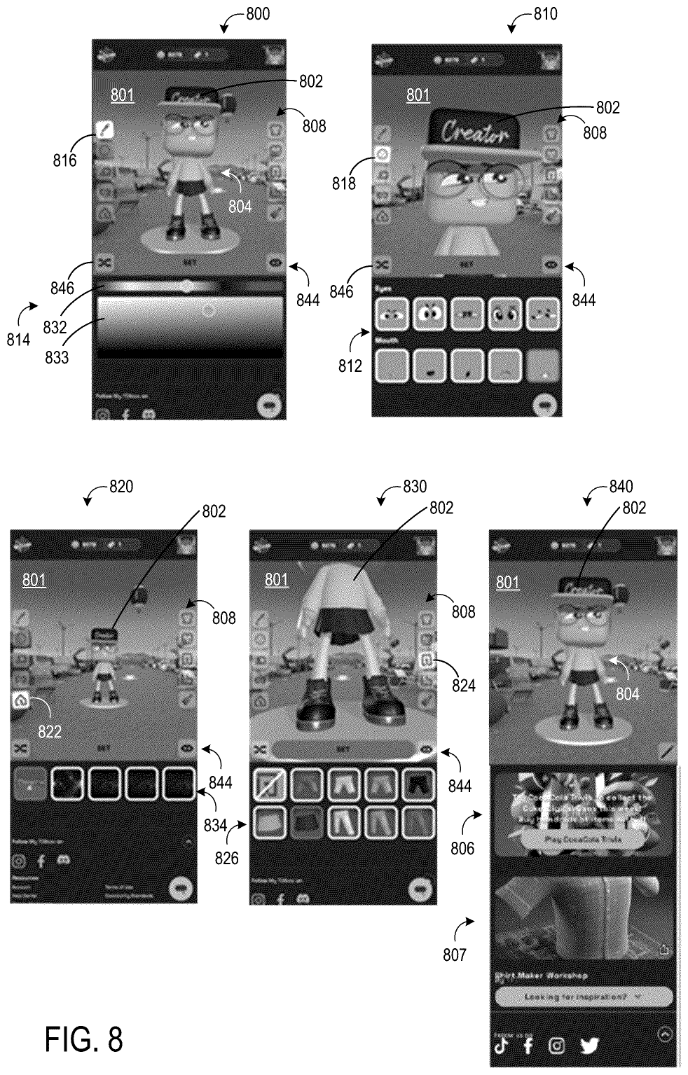

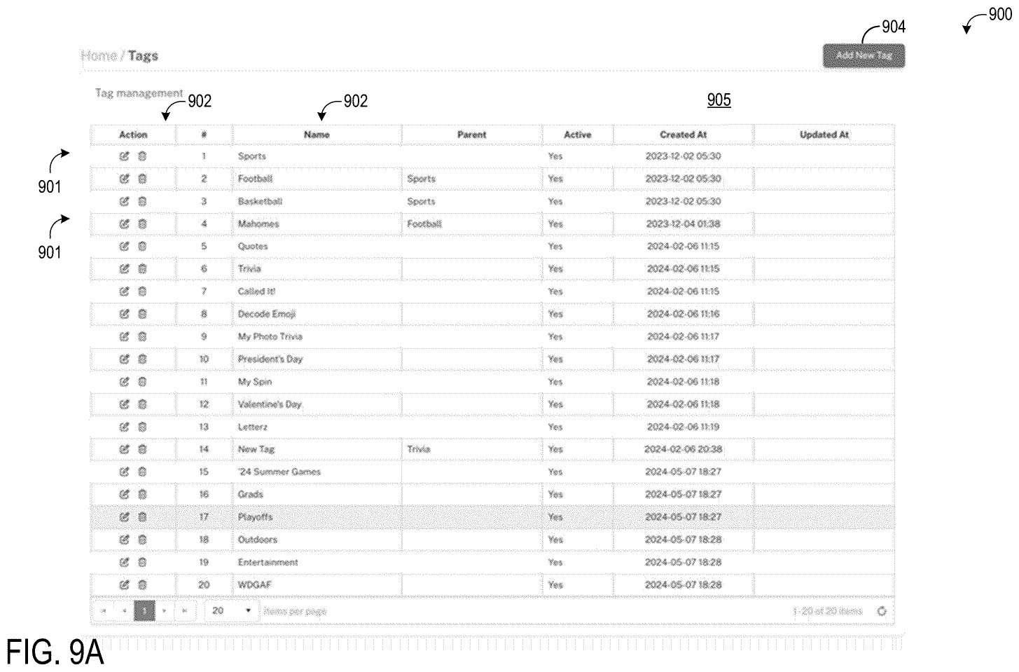

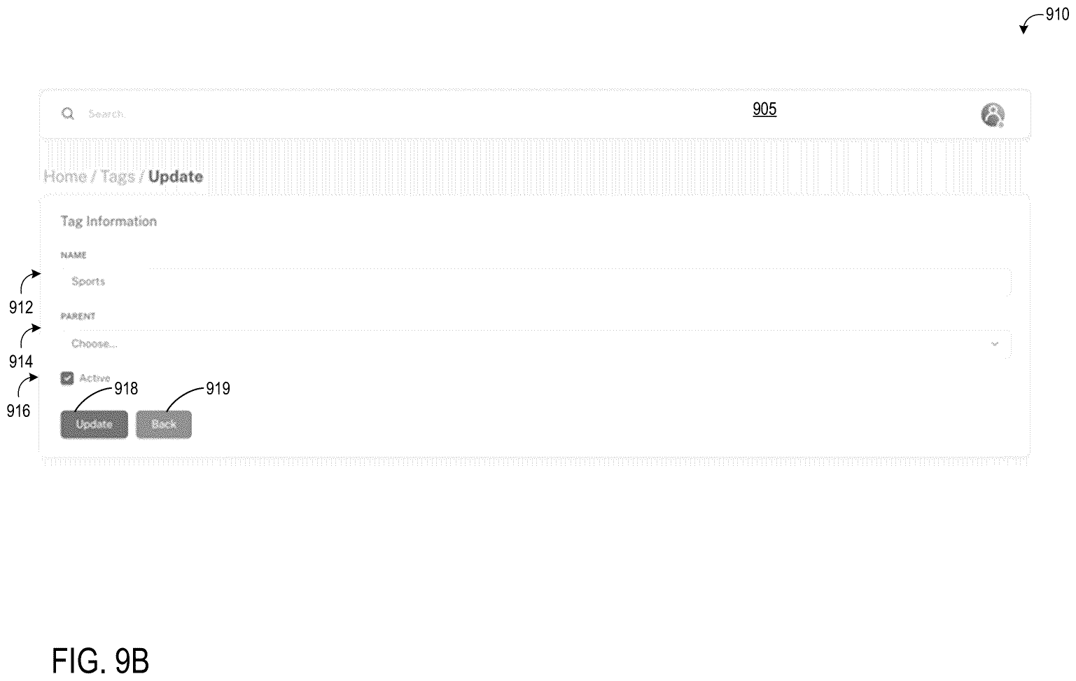

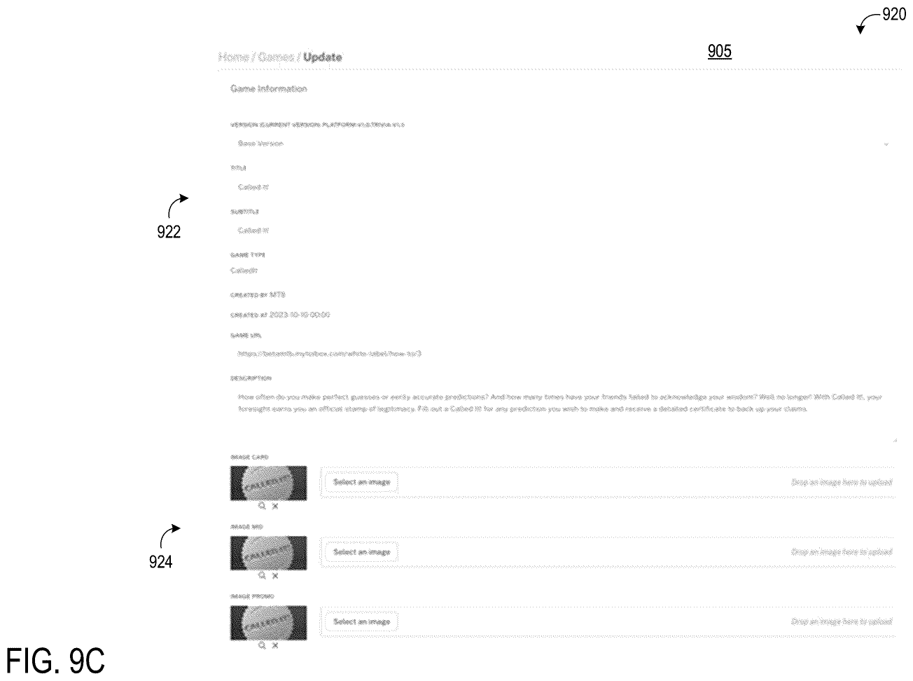

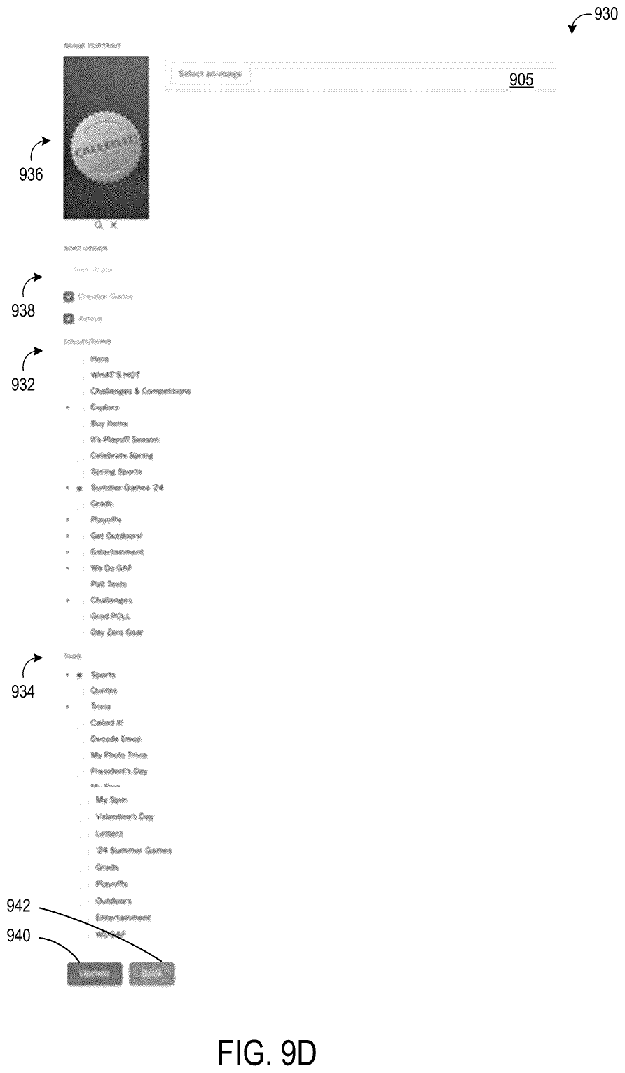

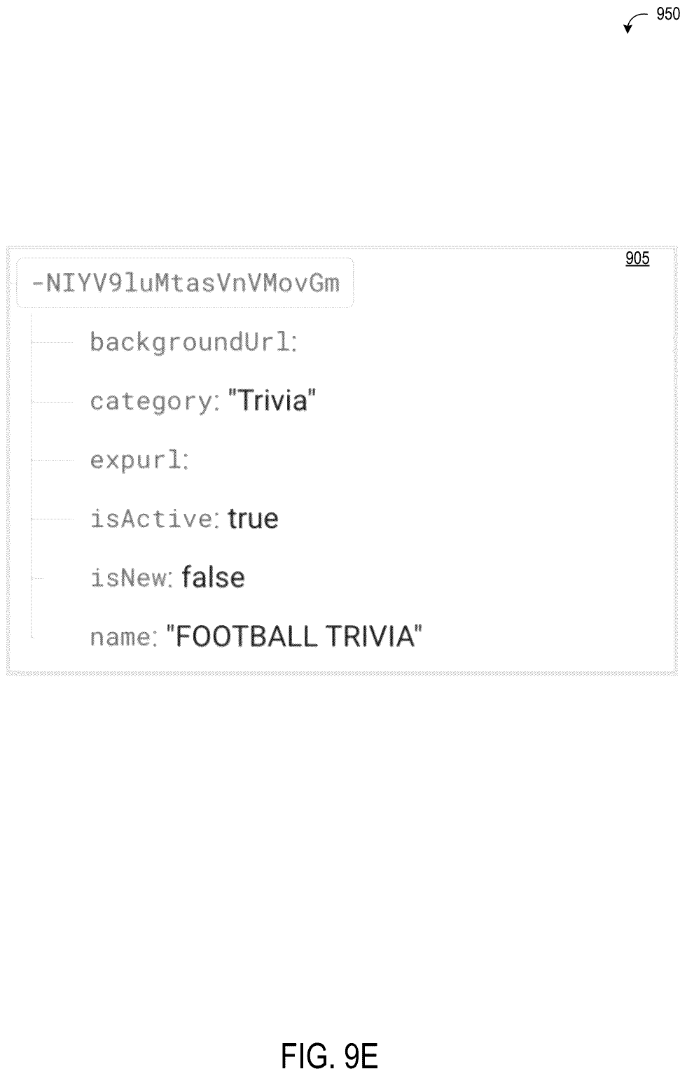

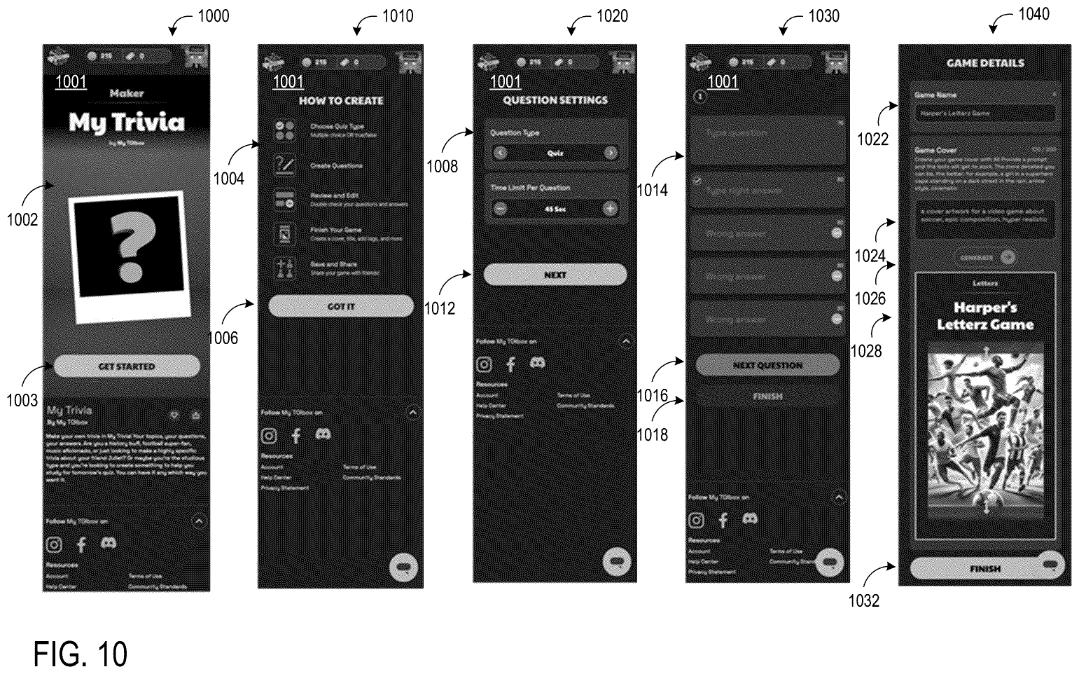

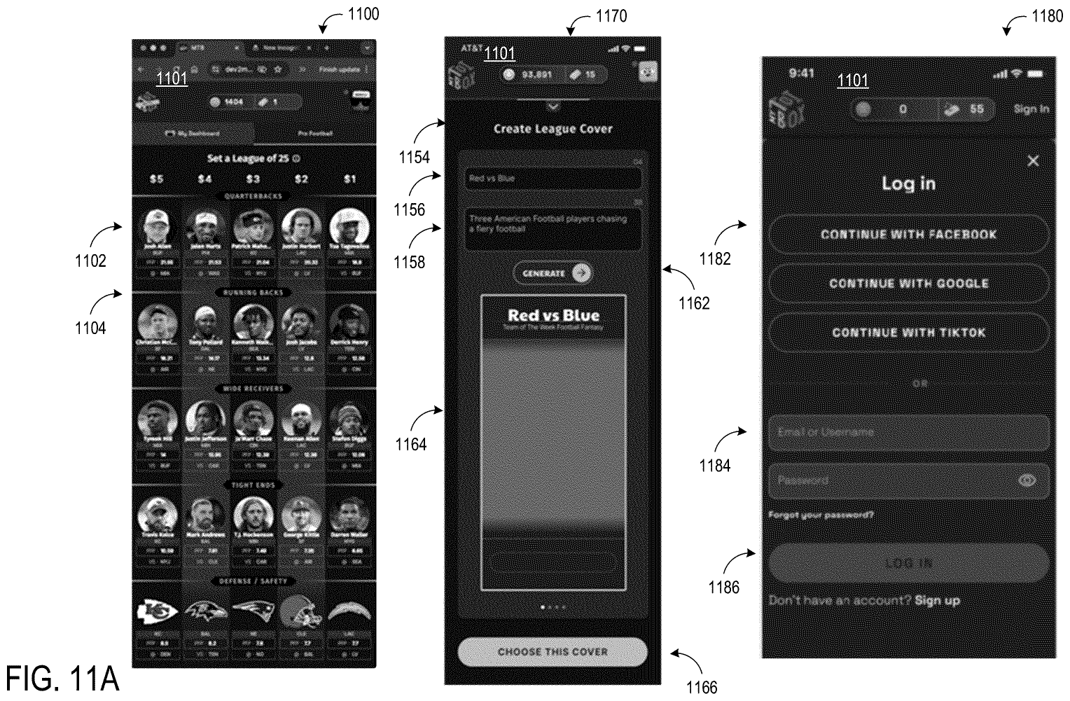

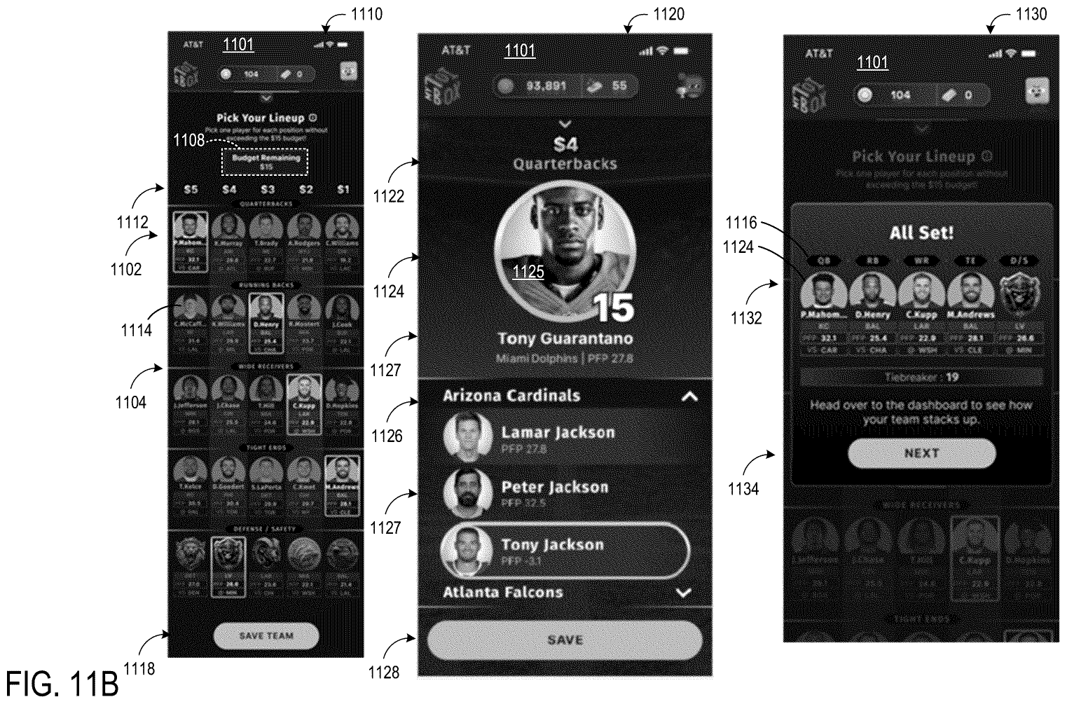

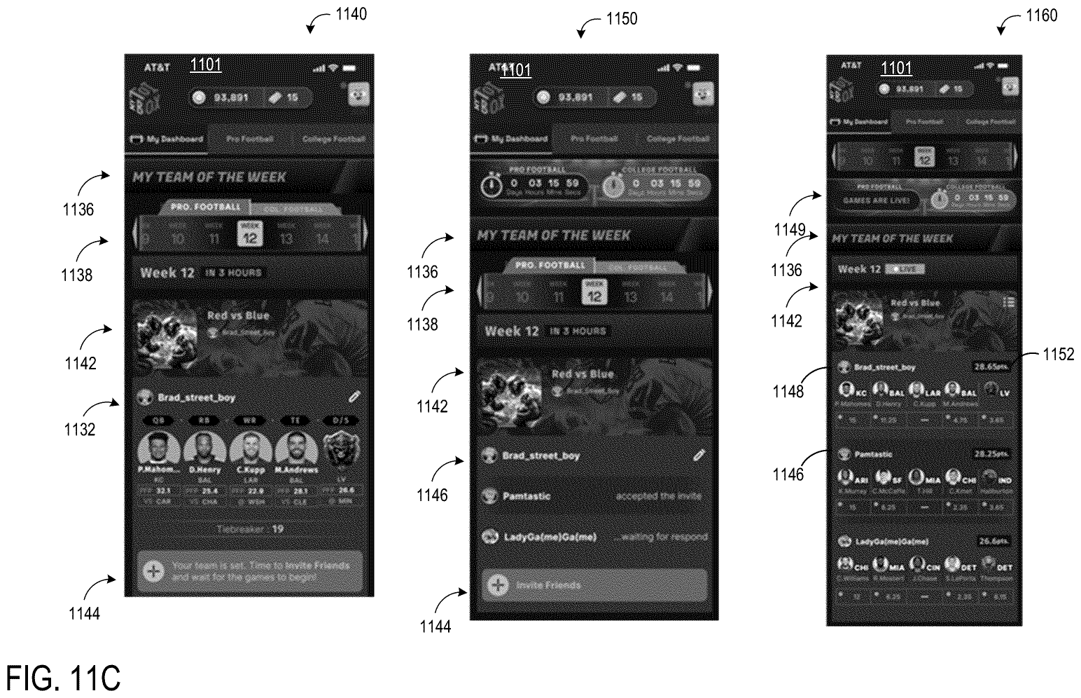

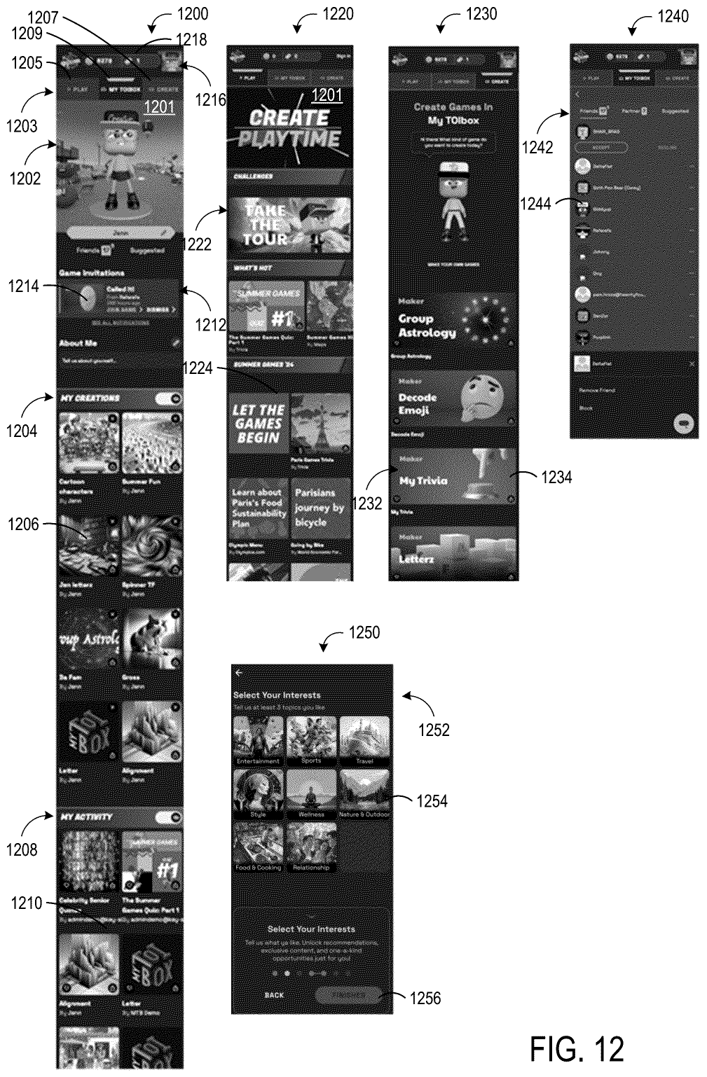

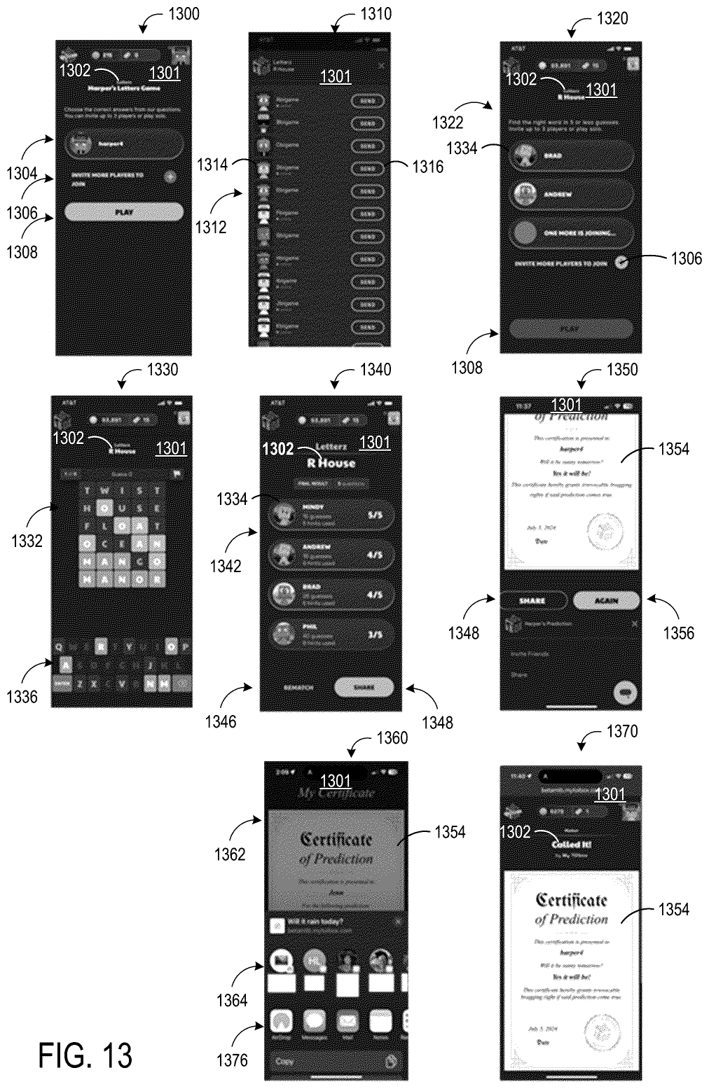

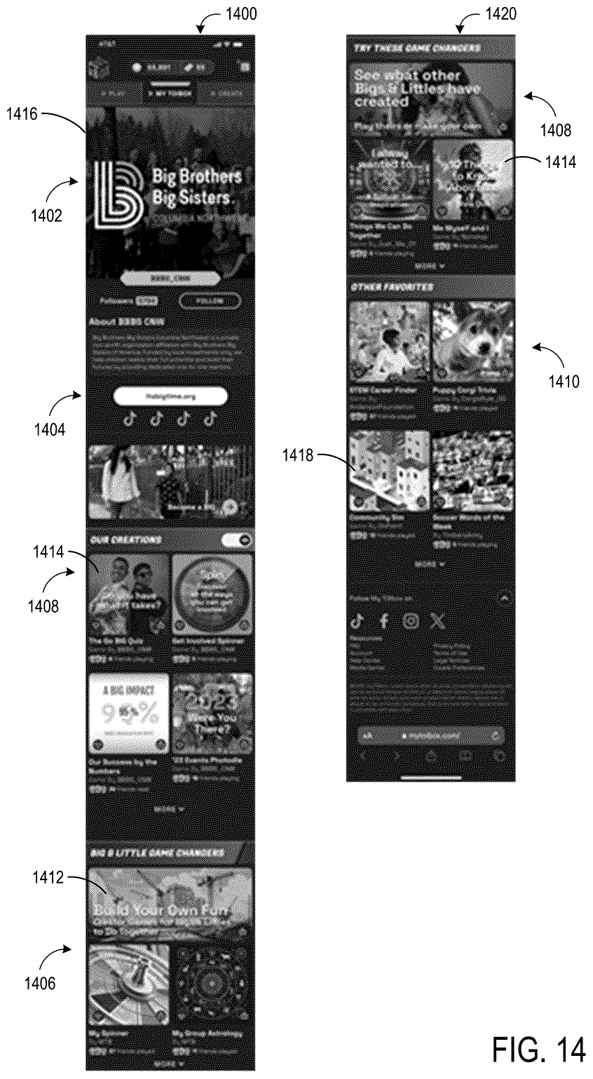

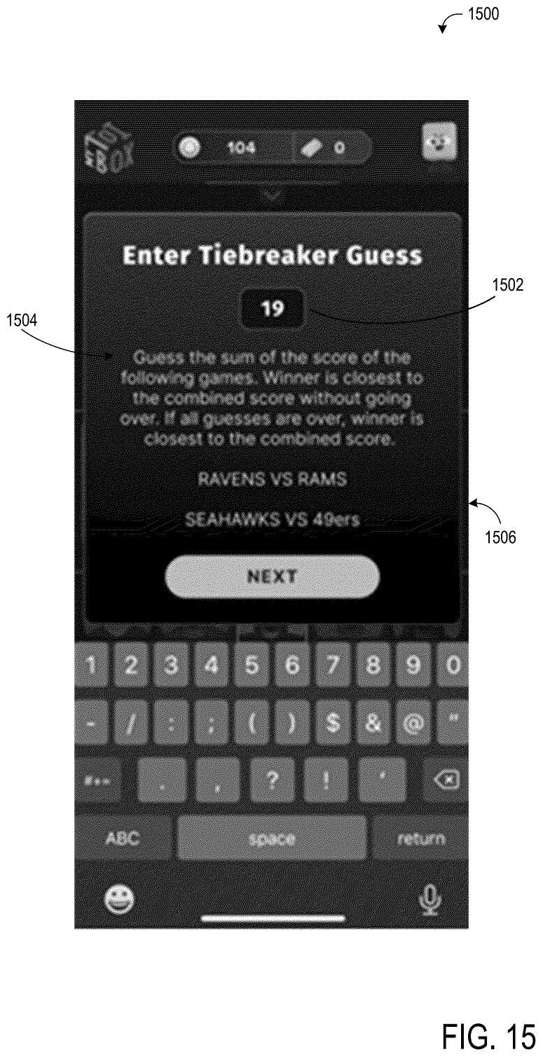

FIG. 8 illustrates example graphical user interfaces that may be rendered by a display of a user computing system as part of a process of creating an avatar on a user account on a social platform. FIG. 9A-9D illustrate server side, Control Panel (C-Panel) interfaces for creating game categories using tags and activating/deactivating tags stored in a database. FIG. 9E illustrates an example game catalogue application programming interface (API), which may be generated as part of creating an original game on a user account of a social platform. FIG. 10 illustrates example graphical user interfaces that may be rendered by a display of a user computing system as part of a process of creating an original game on a user account on a social platform. FIGS. 11A-11C and FIG. 15 illustrate example graphical user interfaces that may be rendered by a display of a user computing system as part of a process of creating a fantasy sports league, such as football, on a user account on a social platform. FIG. 12 illustrates an example of a graphical user interface that may be rendered by a display of a user computing system as part of a process of generating, displaying, and accessing personalized entertainment on a social platform. FIG. 13 shows an example of a graphical user interface that may be rendered by a display of a user computing system as part of a process for creating multiplayer game on the social platform. FIG. 14 illustrates an example of a graphical user interface that may be rendered by a display of a user computing system as part of a process of accessing a marketplace displaying products and entertainment content affiliated with a merchant on the social platform.

FIG. 1A schematically shows an example social platform system 100 including a social platform 102. Social platform 102 may be implemented by one or more computing systems. In one example, social platform 102 may be implemented by a server. In another example, social platform 102 may be implemented by a plurality of computing systems working in concert, such as through a network connection, wherein each of the plurality of computing systems may implement part of the social platform 102. Social platform 102 may be configured to electronically communicate with external computing systems, such as user computing systems 104, 106, and 108, merchants 110, 112, and distribution system 116. In one example, user computing systems 104, 106, 108 may be one or more mobile devices, tablets, and personal computers. In one example, social platform 102 may be configured to electronically communicate with one or more additional computing systems via a network such as the Internet, wherein the electronic communication may in one example comprise transmission and reception of data between the social platform 102 and one or more additional computing systems.

User computing systems 104, 106, 108, which may interface with social platform 102 via a network connection, may each be associated with at least one user and further associated with at least one user account stored in non-transitory memory of one or more a computing systems implementing social platform 102. As an example, use of the term “user” or “platform user” may refer to any individual or individuals who create an account on the social platform 102. Each user computing system may be associated with a user and thus enable the user to communicate with social platform 102. In one example, the user computing systems 104, 106, 108 may be associated with user accounts 122, 124, 126 and may be any associated individual. Users associated with the user computing systems 104, 106, and 108 may register with the social platform 102 and display, create, and interact with user interests 128 generated on the social platform 102. In one example, social platform system 100 may include a plurality of user computing systems associated with a plurality of user accounts. Users associated with the user computing systems 104, 106, and 108 may view and make purchases at a user marketplace 130 generated on the social platform 102. Merchants 110, 112 may sell and promote goods to users associated with the user accounts 122, 124, 126 in a marketplace system 150 generated on the social platform 102.

User computing systems 104, 106, 108 may each include a processor, memory, communication interface, display, user input devices, GPS/position sensors, and/or other components. In one example, a location of user computing system 106 may be determined via a GPS system associated therewith. In one example, information from social platform 102 may be transmitted to user computing system 108 via a network connection (such as the Internet) between user computing system 108 and social platform 102, for rendering within an interface or display implemented at user computing system 106. The display may be used to present a visual representation of the social platform 102. This visual representation may take the form of a graphical user interface (GUI), examples of which are illustrated in FIGS. 8-14. The communication interface may communicatively couple the social platform 102 with one or more other computing systems, such as the distribution system 116, user computing systems, and/or merchant computing systems. The communication interface may include wired and/or wireless communication devices compatible with one or more different communication protocols. As non-limiting examples, the communication interface may be configured for communication via a wireless telephone network, or a wired or wireless local- or wide-area network. User input device(s) may comprise one or more user-input devices such as a keyboard, mouse, touch screen, or game controller.

Merchants 110, 112 may be any merchant, business place, brand, profit business, non-profit business, entrepreneur, or entrepreneurial entity associated with social platform 102. In some examples, merchants 110, 112 may be users having a user account of accounts 120. As an example, use of the term “merchant”, “business”, or “brand” may contemplate any corporation, whether private or public. Each merchant may communicate with social platform 102, for example, via a merchant computing system. Each user computing system may include a processor, memory storing instructions executable by the processor, display, user input devices, and a communication interface. Further, in some examples, merchants 110, 112 may generate personalized digital environments, e.g., a custom page, and may have control panel access, similar to administrator access, wherein the merchants 110, 112 may create custom games, upload products to the marketplace system 150, determine awards for challenges and competitions, view metrics, and so on.

Distribution system 116 may comprise one or more computing devices each including a processor, memory, communication interface, and/or other components. The memory of the computing device(s) of distribution system 116 includes instructions or rules for managing distribution of products sold by merchants in the marketplace system 150. For example, the distribution system 116 may include shipping and/or receiving via one or more logistics and shipping companies. In some examples, distribution system 116 may include discrete accounts (e.g., physical addresses), each of which may be associated with a user account 122, 124, 126 of accounts 120 on the social platform 102. In some examples, the distribution system 116 may include instructions or rules for managing distribution of digital or virtual goods purchased by users via the social platform 102.

Any of the computing devices, modules, or elements described herein with reference to FIG. 1A and FIG. 1B may communicate with each other via a network. For example, social platform 102 may communicate with the user computing systems 104, 106, 108, the merchants 110, 112, and the distribution system 116 via a network.

Social platform 102 may optionally include one or more or all of a plurality of modules including accounts 120, the user interest system 140, a social manager 160, the marketplace system 150, and platform account 170. As illustrated in exemplary FIG. 1B, the various modules of the social platform 102 may include instructions stored in non-transitory memory 190 that are executable by processor 182 of computing system 180. In other examples, the modules may be stored on multiple memories and/or executed by multiple processors distributed across multiple computing devices connected by a network.

Accounts 120 may be a module or database including instructions, information, and/or rules relating to personal and social platform information for each user 104, 106, 108 associated with the social platform 102. As an example, users 104, 106, 108 may register with social platform 102 via a smartphone, computer, or other network-enabled computing device in order to build and create user accounts 122, 124, 126 associated with (as an example) users 104, 106, 108, respectively, the accounts being stored via accounts 120. As an example, accounts 120 may include user information for each platform user, including, for example, one or more or all of user interests 128, user marketplace 130, user rewards 132, and user transactions 134.

User interests 128 may include personalized entertainment content that is displayed and accessed via the account of the user, such as user account 122, on the social platform 102. For example, user interests 128 may include one or more of games, avatars, trophies, badges, last-played game, most-played games, game catalogues, social connections, affiliations, and brands. In one example, badges may be generated through a badge system, and may comprise a graphic that a user earns through participating in challenges, competitions, or other engagement with the social platform 102 that may be displayed on a user's account, such as user account 122. For example, in some cases, a badge may represent a trophy. In other examples, users may earn badges passively, receive badges as a gift, or purchase a badge. User interests 128 may be user-generated and/or user-customized, such as by one or more of user accounts 122, 124, 126, through modules of the user interest system 140 accessed via the social platform 102.

In some examples, games may include professionally developed flagship titles provided by the social platform 102, such as created by administrators 172. In other examples, games may include user-generated content created by independent developers or enthusiasts using the maker template 146 or other game customization tools via the social platform 102. A game on the social platform 102 may include a game name, game cover or other key visual, a game description, game tags, hints, and custom challenges. In some examples, the social platform 102 may include one or more tools for third-party brands/community partners to integrate their own services, or games into the platform ecosystem.

User marketplace 130 may include a personalized marketplace of goods that are available for purchase via the social platform 102. In some examples, user marketplace 130 may include certain marketplace items that are made available for purchase in response to the user unlocking access via completing a challenge, participating in a competition, or through purchase. In a few examples, the user marketplace 130 may be stocked based on user interests 128, interaction with the social platform 102, and participating merchants, sponsors, and so on. For example, user marketplace 130 may include one or more of custom avatar pieces for an avatar of a user, sponsor-related products, experiences, digital elements for auction and/or purchase. User marketplace 130 may include digital goods and physical goods sourced by platform account 170 having one or more administrators 172, as well as user-generated goods, such as generated by one or more of user accounts 122, 124, 126, through modules of the user interest system 140 accessed via the social platform 102.

In some examples, digital goods may include one or more of virtual objects, assets, and currencies that exist within the social platform 102. The value and rarity of digital items in a game platform, such as the social platform 102, may be determined by factors such as in-game rarity, demand, popularity, and scarcity. Some digital items may be limited edition, exclusive, or have special attributes that increase their value. Digital items are stored and preserved within the servers or databases of the social platform 102. In some examples, one or more digital items may expire, have time frames, become irrelevant, and so on, and thus be removed from the database. In other examples, one or more digital items may not degrade over time and may be accessed as long as the social platform 102 remains operational. In some examples, digital items may be rewarded, purchased, or gifted.

In some examples, physical goods may include tangible goods or products that are represented digitally through images, descriptions, and other metadata in the marketplace but exist as physical entities that can be purchased, gifted and shipped to a user. In some examples, purchase filters, such as an age threshold, to purchase some physical items.

User rewards 132 of a user's account may include the rewards for which the user is currently eligible based on user interaction with the social platform 102. In one example, user rewards 132 may be used to purchase items in the user marketplace 130. As another example, user rewards 132 may be used to enter competitions on the social platform 102. In one example, user rewards 132 may comprise a bank of points, which may include more than one category of points. For example, user rewards 132 may include in-game currency that can be earned or purchased with real currency. As used herein, real currency may refer to credit cards, debit cards, virtual wallets, or other devices capable of conducting electronic transactions, which are associated with a payment account, such as a checking account. In some examples, user rewards 132 may be awarded by playing in activities, games, completing challenges, and/or participating in competitions. In other examples, user rewards 132 may be awarded by winning games and/or competitions. In one example, user rewards may be awarded by completing in-platform tasks or challenges, which are tasks for users to carry out with no competition from other users, e.g., “Customize your Avatar”. User rewards 132, such as in-game currency, may be spent on physical or digital goods, and may be combined with real currency in a transaction.

User transactions 134 may include a history of tracked user purchases executed by a user using user rewards 132 or real currency and tracked by the social platform 102 via platform account 170. User transactions 134 may communicate with distribution system 116 for receiving purchased goods.

Help desk 136 may include resources, tutorials, and support relating to user information for each platform user, including, for example, one or more or all of user interests 128, user marketplace 130, user rewards 132, and user transactions 134. In one example, the help desk 136 may be managed by one or more administrators 172. In other examples, additionally, or alternatively, users may moderate or contribute to the help desk 136. For example, the help desk 136 may include forums where users may share and collaborate with other platform users.

User interest system 140 may include one or more modules for customizing user interests 128 for a user, such as a user of user accounts 122, 124, or 126, including, for example, generating personalized entertainment content such as avatars, games, trophies, social connections, user-generated art and goods. In one example, the one or more modules are configured to present a plurality of input controls for generating one or more user interests 128 by the social platform 102. In one example, user interest system 140 may include one or more or all of avatar creator 142, game tag system 144, maker template 146, league creator 148, and image generator 149. In one example, avatar creator 142 enables users to create a customized online representation affiliated with social platform 102, which may be a user-generated character including clothes, hair, skin, accessories, avatar environment, etc. An example method for avatar creator 142 is shown in FIG. 3. In another example, game tag system 144 is a simple, user-selected categorization system which tags games allowing for precise game suggestion algorithms and content delivery. An example method for suggesting, selecting, or tagging games via a game tag system 144 is shown in FIG. 4. As a further example, maker template 146 is a simple, yet scalable, game metadata creation tool which simplifies game creation and sharing. An example method for maker template 146 is shown in FIG. 5. In another example, league creator 148 enables users to create a fantasy football or other fantasy leagues quickly and without player knowledge. For example, the league creator 148 may be configured for generating a fantasy sports league based on sports data loaded from an application programming interface (API), an automatically suggested league comprising a plurality of players at a plurality of positions based on the sports data, and user input to a roster customization interface. An example method for league creator 148 is shown in FIG. 6. In another example, image generator 149 allows users to quickly and efficiently create game cover art for user-generated games affiliated with social platform 102. An example method for image generator 149 is shown in FIG. 7. Generating personalized entertainment content and sharing user-generated entertainment content across platforms is not so simple. Whereas existing platforms struggle to connect with potential users by having overly complicated interfaces that may be a barrier to entry for general audiences, the modules disclosed herein for customizing the user interests 128, such as the examples shown in FIGS. 3-7, are quick, efficient, and simpler to use than existing approaches.

Marketplace system 150 may include one or more modules and databases including instructions, information, and/or rules relating to goods displayed, generated, sold, and/or auctioned on the social platform 102. For example, the marketplace system 150 may include one or more modules for engaging with a plurality of marketplaces including personalized marketplaces curated for users, such as user marketplace 130, marketplaces curated by particular merchants, brands, and/or sponsors, as well as marketplaces created by users, such as user account 122. In one example, marketplace system 150 may include one or more processes through which brands affiliated with the social platform 102 may connect with users of the social platform 102. For example, a brand (e.g., one of merchants 110, 112) may create a virtual environment (e.g., a webpage) on the social platform 102 that user accounts 122, 124, 124 may access to engage with the brand. The virtual environment may include brand-selected and/or brand-generated content including games, interests, promotional content, and goods for purchase with user rewards 132 and/or real currency. In another example, marketplace system 150 may include one or more processes through which user-created goods may be made available for purchase on the social platform 102.

Optionally, social manager 160 may administer social policies 162 and update user interests 128 of accounts 120 with updated social policies relating to entertainment content from which a user may make a user interest selection. Social policies 162 may further include instructions or information relating to managing of the accounts 120 of the social platform 102. In some examples, social policies 162 may include tools for community moderation to maintain an enjoyable environment for all users, including reporting systems, and user conduct guidelines. Social manager 160 may optionally include one or more or all of games 164, user identity 165, merchants 166, and promotions 168. Merchants 166 may be a database or module that may further represent suitable information regarding merchants, brands, businesses, sponsors, etc., affiliated with social platform 102, such as entertainment content and products offered, as well as tags to categorize merchants into interest groups. Optionally, such information may be stored in merchant index 192 shown in FIG. 1B. Games 164 may be a database or module which may further represent suitable information regarding games affiliated with social platform 102, and may include, for example, user-generated content, platform-generated content, and merchant-generated content, as well as tags to categorize user interests into interest groups, such as created and/or selected via the game tag system 144. In one example, social manager 160 may include tags or categories for games such as “multi-player”. In one example, platform administrators may create tags, and users and merchants may select the tags when creating a game, which will enable game suggestion algorithms to grow audiences as they allow users to be made aware of games on the social platform 102. In another example, additionally, or alternatively, one or both of users and merchants may be able to create tags, such as custom tags that are user or merchant defined during game creation. Optionally, such information may be stored in game index 194 shown in FIG. 1B. In one example, the game tag system 144 may enable users the ability to curate their own personalized content and may give the social platform 102 the ability to push games and other content to the users based on their selected tags. User identity 165 may be a database or module which may represent account customization content, such as, for example, avatars and avatar-wearables, as well as user ID tags to match account customization content with user accounts. Optionally, such information may be stored in an avatar wearables index 196, shown in FIG. 1B. In another example, user identity 165 may include one or more databases or modules which may represent user-generated art, user-generated digital environments. Optionally, such information stored in an art index 197 shown in FIG. 1B. Social manager 160 may represent suitable information regarding promotions 168 of the social platform 102. For example, the social manager 160 may communicate with merchants, brands, businesses or other entities affiliated with the social platform 102 to promote entertainment content, user behavior, and goods. Such information may be stored in one or more of a promotions index 198 shown in FIG. 1B.

The social platform 102 may include platform account 170, which may comprise one or more administrators 172. Administrators 172 may be enabled via the platform account 170 to make modifications to the social platform 102, for example, via the social manager 160 and the marketplace system 150, and modifying user access via accounts 120. In some examples, the one or more administrators 172 may moderate data and content, such as with regard to social policies 162.

Turning now to FIG. 1B, example computing system 180 is shown. Computing system 180 may implement social platform 102 alone, or in combination with other computing systems. In one example, computing system 180 may comprise a server. Computing system 180 includes display 184, input device 186, processor 182, network adapter 188, and non-transitory memory 190.

Display 184 may comprise a monitor, touch screen, projector, or any other device known in the art of computers for enabling a user to observe or sense information rendered by a digital device. Computing system 180 may have stored within non-transitory memory 190 instructions for rendering data, such as social platform 102 data, within a graphical user interface. The data may be displayed via the graphical user interface by display 184.

Input device 186 enables a user to interface/interact with computing system 180, and may comprise one or more hardware devices, such as a mouse, keyboard, touch screen, motion tracking camera, or other devices configured to transform user motions, gestures, sounds, or other user actions into an electronic form which may enable a user to input data, or transmit, select, modify, or otherwise interact with data or data structures stored in or displayed by computing system 180.

Processor 182 may include one or more physical devices configured to execute instructions stored in non-transitory memory. For example, processor 182 may be configured to execute instructions that are part of one or more applications, services, programs, routines, libraries, objects, components, data structures, or other logical constructs included in social platform 102.

Network adapter 188 may comprise one or more physical device associated with computing system 180, enabling transmission, and reception of data between computing system 180 and one or more additional computing systems. Network adapter 188 may enable computing system 180 to access a local area network, and/or the Internet, and exchange data therewith, such as data which may enable tracking of user purchases and matching between transacting merchants registered with the social platform.

Non-transitory memory 190 includes one or more physical devices configured to hold data, including instructions executable by the processor to implement the methods and processes described herein. When such methods and processes are implemented, the state of non-transitory memory 190 may be transformed—e.g., to hold different data. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 190 includes the various files/routines/methods of social platform 102 that when executed by processor 182 perform one or more of the steps herein described with reference to one or more of the disclosed methods. Computing system 180 may optionally include display(s), user input device(s), communication interface(s), and/or other components. In one example, non-transitory memory 190 may comprise a non-transitory machine-readable storage medium including instructions that when executed by a machine cause the machine to perform operations, such as the operations described in one or more the methods disclosed herein.

Non-transitory memory 190 optionally includes one or more of merchant index 192, game index 194, avatar wearables index 196, art index 197, and promotions index 198. Merchant index 192 may be stored within non-transitory memory 190 of computing system 180, and may comprise a database or module containing information regarding merchants, businesses, sponsors, and brands registered with social platform 102. In one example, merchant index 192 may be used by computing system 180 in conjunction with accounts 120, user interest system 140, and marketplace system 150 to personalize user marketplaces such as user marketplace 130. For example, computing system 180 may be configured to implement one or more algorithms, such as an interest filtering tool, to estimate a likelihood that one or more users 104, 106, 108 may engage with one or more merchants 110, 112 stored in the merchant index 192. Similarly, game index 194 may be stored within non-transitory memory 190 of computing system 180, and may comprise a database or module containing information regarding games and game-related content on the social platform 102.

Avatar wearables index 196 may be stored within non-transitory memory 190 of computing system 180, and may comprise a database or module containing information regarding avatar wearables and other platform-identity customization tools, as well as user ID tags to match avatar customization content with user accounts on the social platform 102. Similarly, art index 197 may be stored within non-transitory memory 190 of computing system 180, and may comprise a database or module containing information regarding other platform customization tools, as well as user ID tags to match customization content with user accounts on the social platform 102. One or more or all of game index 194, avatar wearables index 196, and art index 197 may be used by computing system 180 in conjunction with accounts 120, user interest system 140, and marketplace system 150 to personalize entertainment content. Further optionally, promotions index 198 may be stored within non-transitory memory 190 of computing system 180, and may comprise a database or module containing information regarding promotion and sponsor-related information on the social platform 102

FIG. 2A shows a schematic diagram 200 illustrating platform user and merchant interaction with the marketplace system 150. The schematic diagram 200 represents one exemplary embodiment of a system for creating personalized entertainment content on a social platform, such as social platform 102. Marketplace system 150 include processes for creating a plurality of marketplaces 202 by a plurality of merchants 110, 112 and a plurality of users 104, 106, 108. Marketplace system 150 further includes processes for suggesting goods created and/or sold by merchants 110, 112 to users 104, 106, 108 in personalized marketplaces on user accounts 122, 124, 126, such as user marketplace 130 in FIG. 1A. Elements of FIG. 2A that were previously illustrated and described above shall retain their numbering in FIG. 2A.

The marketplaces 202 discussed with reference to FIG. 2A may comprise instructions stored in non-transitory memory of a computing system, such as a computing system 180 implementing social platform 102, wherein the instructions enable the marketplaces 202 to display, promote, and sell goods. For example, merchant 110 may create and manage a marketplace 204, merchant 112 may create and manage a marketplace 208, and user 108 may create and manage a marketplace 208 via user account 126. In a few examples, marketplaces 202 may include custom avatar pieces, sponsor-related products, experiences, digital elements, hard goods, and user-generated art. Products displayed in marketplaces 202 may be purchased using user rewards, such as user reward 132, or real currency in some examples.

In some examples, the marketplaces 202 may be accessed by a plurality of users, such as users 104, 106, 108, via user accounts, such as user accounts 122, 124, 126. For example, user 104, e.g., via user account 122, may visit the marketplace 204 created by the merchant 110. For example, the marketplace 204 may be a webpage or other digital environment on the social platform 102 created and managed by the merchant 110. In such an example, the merchant 110 may display products, experiences, promotional content, and so on, in the marketplace 204 that are for purchase by users using user rewards, such as user rewards 132. Similarly, users 104, 106, 108 may visit marketplace 206, which may display products, experiences, promotional content, and so on that are stocked by merchant 112. As another example, the marketplace 208 may be a digital environment on the social platform 102 created and managed by user 108 via user account 126. For example, the user 108 may display virtual products, real products, entertainment content, and so on, in the marketplace 208 for sale or auction to other users, such as users 104, 106, 108.

In other examples, personalized marketplaces, such as user marketplace 130, may be generated for users, and displayed on user accounts, such as user accounts 122, 124, 126. The user marketplace 130 may be a webpage or other digital environment accessible via the social platform 102. User marketplaces, such as user marketplace 130, may display products, experiences, promotional content, and so on that are stocked by a plurality of merchants 110, 112 that are affiliated with the social platform 102. In some examples, the user marketplace 130 may be stocked based on user preferences, user interaction with the social platform, and/or participating merchants. For example, the social platform 102 may operate suggestion algorithms to enable user marketplace personalization.

In one example, a suggestion algorithm may be based on user input provided by the user to the user's account, such as, for example, user interests, friends, and account settings. The suggestion algorithm may be further based on user interaction with the social platform, such as, for example, games played by interest tag, scores achieved by interest tag, time spent on individual games, interaction with one or more marketplaces via auctions, user transactions (e.g. purchase history), and various other factors. Further, the suggestion algorithm may be adapted to optimize for user engagement. In some examples the suggestion algorithm may be initiated with a limited data set, such as for example, interests provided and tags interacted with. Additional factors may be integrated over time based on the specific user interaction.

FIG. 2B shows a schematic diagram 250 illustrating platform user and merchant interaction with the user interest system 140. The schematic diagram 250 represents one exemplary embodiment of a system for creating personalized entertainment content on a social platform, such as social platform 102. User interest system 140 includes processes for creating a plurality of games 252 by a plurality of users 104, 106, 108 and a plurality of merchants 110, 112. User interest system 140 further includes processes for suggesting games created by users 104, 106, 108 and merchants 110, 112 to other platform users for display and engagement with on user accounts 122, 124, 126, such as displayed via user interests 128 in FIG. 1A. Elements of FIG. 2B that were previously illustrated and described above shall retain their numbering in FIG. 2B. While FIG. 2B represents an exemplary embodiment for creating and sharing games on the social platform, it may be understood that similar system may be applied to creating and sharing other categories of entertainment content on the social platform including, but not limited to, avatars, user-generated art, digital experiences, books, movies, music, and so on.

The games 252 discussed with reference to FIG. 2B may comprise instructions stored in non-transitory memory of a computing system, such as a computing system 180 implementing social platform 102, wherein the instructions enable users 104, 106, 108 and merchants 110, 112 to create, suggest, promote, and customize the games 252. For example, merchant 110 may create a game 256, merchant 112 may create a game 258, user 104 may create a game 254, and user 108 may create a game 260. In a few examples, games 252 may include trivia, spinner games, fantasy sports leagues, and competitions or challenges within existing games.

In one example, users 104, 106, 108 may navigate through one or more game catalogues and select one or more of the plurality of games 252 from the catalogue. Additionally, or alternatively, games 252 may be displayed, promoted, pushed and/or suggested to users and displayed on their accounts based on user preferences, platform use, promotions, and so on. By selecting one or more of games 252, such as game 254, the game may be displayed among personalized entertainment content, such as via user interests 128 on user account 122. In some examples, the user may play the game via their account to accumulate user rewards, which may be used in a personalized marketplace, such as marketplace 130. For example, user interests 128 displayed on user account 122 may include game 256 and game 260. User interest displayed on user account 126 may include game 256 and game 258. User interests displayed on user account 124 may include game 256, game 258, and game 260.

Turning to FIG. 3, an example method 300 for creating an avatar is shown. The method 300 may enable building animation and game ready assets in a simpler to use user interface than existing gaming platforms. In one example, the method 300 may be stored in non-transitory memory of a computing system implementing a social platform, such as computing system 180, and one or more, or all, of the steps of the method 300 may be automatically executed by the social platform, or by one or more subcomponents, modules, databases, or subsystems of the social platform. In one example, the method 300 may be executed as part of an avatar creation system, such as the avatar creator 142 described with reference to FIG. 1A. Actions illustrated in the method 300 include server side actions and client side actions, which are separated by dashed lines. Examples of an avatar creator graphical user interface is shown in FIG. 8.

The method 300 initiates in response to a social platform, such as social platform 102, determining that a user has accessed a startup screen associated with a user account.

At 302, the method may include loading a portion of or all avatar wearables from a database. In one example, the database may be the avatar wearables index 196 shown in FIG. 1B.

At 304, the method may include displaying an avatar and a plurality of avatar wearables associated with the user account of the user. In one example, the avatar may be a template body or form with minimal decoration that may be customized according to the methods disclosed herein. In another example, additionally, or alternatively, the avatar may be a custom avatar, which may be displayed wearing a plurality of avatar wearables that were selected by the user at some previous time according to the methods disclosed herein. Avatar wearables may include one or more or all of clothing, accessories, such as hats, jewelry, and shoes, expressions, skin color, facial features, or avatar environments.

Avatar wearables may further include badges, trophies, or similar, that are earned through interaction with the social platform. In some examples, displaying the plurality of avatar wearables may include displaying one or more customizer tools, such as a color bar, with which the user may use to further customize the avatar wearables by modifying the color or design of a selected wearable. In one example, categories of wearables may be displayed one-at-a-time in response to a user clicking a button, such as an icon, associated with the category. As used herein, button may refer to any type of user input that provides a user a mechanism to select, confirm, or otherwise indicate a choice. For example, in response to the user clicking a hat icon, the method may include displaying all hats owned by the user that the avatar may wear. In one example, user ID and matching avatar wearables may be stored in the avatar wearables index 196 shown in FIG. 1B. In one example, user ID may include a user-wearables table stored in a real-time database. The user-wearables table may act like a many-to-many relationship between wearables and user tables.

At 305, the method 300 may include determining whether user selection of one or more avatar wearables is received. In one example, the user selection may be determined in response to the user clicking one or more input controls, such as a widget, icon or button, representing an avatar wearable. In response to receiving the user selection of the avatar wearable, the method 300 may continue to 307 to display the selection on the avatar.

If a user selection of one or more avatar wearables is not received, the method 300 may continue to 306, where the method 300 may include determining whether a command to generate a random selection of avatar wearables is received. In one example, the command may be determined in response to the user clicking a randomize button. In response to receiving the command, the method 300 may generate a random selection of avatar wearables for the avatar at 312 and display the random selection on the avatar at 314.

If the command to generate a random selection is not received, the method 300 may continue to 308, where the method 300 may include determining whether a command to display a viewing mode is received. In one example, the viewing mode may be a mode of a graphical user interface where the screen is cleared of some or all icons to enable a clear view of the avatar and its wearables. In one example, the command may be determined in response to the user clicking a button. In response to receiving the command, the method 300 may continue to 316, where the method 300 may include clearing the screen of icons to view the avatar in isolation.

If the command to display the viewing mode is not received, the method 300 may continue to 310, where the method 300 may include determining whether a command to save the selection is received. In one example, the command may be determined in response to the user clicking a button to update the avatar. If the command to save the selection is not received, the method 300 may return to 305, where more user selections of avatar wearables may be received and displayed. For example, the user may select multiple wearables, which may each be displayed on the avatar upon selection, such as various accessories, an expression, articles of clothing, shoes, a background, and so on. For example, the user may select a first expression, the first expression may be displayed on the avatar, and then the user may select a second expression, which replaces the first expression displayed on the avatar. In one example, the user selection and display process may repeat continuously until the command to save the selection is received, or an indication to exit the avatar creator GUI is received.

In response to receiving the command to save the user selection, the method 300 may include saving the user choices into a game ready file for use in games at 318. For example, the user choices may be saved as a first file for use in games. In some examples, games may use an avatar directly in the game play. For example, animations of the avatar may be integrated into different activities presented on the social platform, such as reacting to live results of a competition, or interacting with the social platform environment through immersive reality games.

At 320, the method 300 may include saving the current user's avatar as a second file for use in 2D applications. For example, the avatar may be saved for display in a share panel, friend panel, or scoreboard on the social platform.

The disclosed approach simplifies avatar creation in a number of ways, including, but not limited to, reducing user-interface complexities and reducing processing time. For example, the approach is based around a single avatar model that allows for user expression through the use of digital clothing and accessories. The avatar creation system is sufficiently robust for users preferring self-directed customization, while offering a one-click, easy-to-use randomize option for users who select such an option. Once the avatar is created, the avatar may be imported into the games the user plays automatically and without 3D modeling, rigging, or animation experience. While existing gaming systems may allow for avatar customization, such systems do not provide a one-click, randomize option that is preferable to some users. Further, while existing gaming systems may export a game ready asset, such systems may not provide a platform in which to use them or user customizable game templates to create experiences based around them.

Turning to FIG. 4, an example method 400 for categorizing entertainment content is shown. In one example, the method 400 may enable a user categorization system that tags games allowing for better game suggestion algorithms and content delivery than existing gaming platforms. In one example, the method 400 may be stored in non-transitory memory of a computing system implementing a social platform, such as computing system 180, and one or more, or all, of the steps of the method 400 may be automatically executed by the social platform, or by one or more subcomponents, modules, databases, or subsystems of the social platform. In some examples, the user may be a merchant associated with the social platform. In other examples, additionally, or alternatively, the user may be an individual associated with a user account on the social platform. In one example, the method 400 may be executed as part of a game tag system, such as the game tag system 144 described with reference to FIG. 1A. Actions illustrated in the method 400 include server side actions and client side actions, which are separated by dashed lines.

At 402, the method 400 may include a control panel or C-panel configured to allow creation of tags, updating of tags, and addition of tags to a game tag picker. The game tag picker may be a portion of a user interface displaying one or more selectable tags. The C-panel may be accessed by one or more platform administrators, such as, administrator 172 of platform account 170 in FIG. 1A. In some examples, additionally, or alternatively, users and/or merchants may access a C-panel to allow creation of personalized tags. In one example, tags may include categories and descriptors that allow for game creators and/or game users to navigate a game catalogue and to suggest games to other users. Example C-panels showing an example administrator-side interface for creating and controlling tags is shown in FIGS. 9A-D.

At 403, the method 400 may include displaying the administrator C-panel interface wherein one or more platform administrators may activate or deactivate tags from the game tag picker. Activated tags may be displayed to users on the game tag picker and deactivated tags may be removed from the game tag picker. An example interface for administrator tag activation and deactivation is shown in is shown in FIG. 9B.

At 404, the method 400 may include displaying the tags in the game tag picker. In one example, tags may be loaded from the game index 194 shown in FIG. 1B. In one example, the game tag picker may include selectable buttons associated with each tag that a user may click to indicate selection of the tag. An example interface for a tag picker displaying tags is shown in FIG. 9D.

At 406, the method 400 may include determining user confirmation of selected tags. For example, the method 400 may include prompting the user to confirm the selection by clicking a button.

At 408, the method 400 may include storing user-chosen tags in the database for user-generated games.

At 410, the method 400 may include suggesting games to other users with preferences that match tags based on a game suggestion algorithm. In one example, the game suggestion algorithm may be based on user interests, account settings, and/or user interaction with the social platform

The disclosed approach illustrated by the method 400 simplifies game tagging in a number of ways. For example, the approach feeds into an algorithm that suggests content based on user input and how users interact with our platform. Further, where users on other gaming platforms are not able to tag games with interest categories, or are not able to use those tags to categorize games they have created on those platforms for sharing purposes, the system and methods for tag creation disclosed herein allows users to create and add tags.

Turning to FIG. 5, an example method 500 for a maker template is shown. The method 500 may enable game metadata creation and game catalogue population in a scalable, simpler to use user interface than existing gaming platforms. In one example, the method 500 may be stored in non-transitory memory of a computing system implementing a social platform, such as computing system 180, and one or more, or all, of the steps of the method 500 may be automatically executed by the social platform, or by one or more subcomponents, modules, databases, or subsystems of the social platform. In one example, the method 500 may be executed as part of a maker template system, such as maker template 146 described with reference to FIG. 1A. Actions illustrated in the method 500 include server side actions and client side actions, which are separated by dashed lines.

At 502, the method 500 may include causing presentation of a computer-guided process that enables the following exemplary steps.

At 504, the method 500 may include displaying a template which enables filling in settings for a user-generated trivia game. For example, the template may display for user selection one or more of a quiz type, e.g., true/false, short answer, a quiz duration, e.g., timed answer, untimed, etc., and one or more input boxes to receive user-generated questions and answers. An example interface for filling in settings for a user-generated trivia game template is shown in FIG. 10.

At 506, the method 500 may include receiving user input via the template. For example, the user may navigate through the template by clicking on one or more input controls such as buttons, responding to prompts, filling in blanks, or otherwise interacting with the template thorough the interface.

At 508, the method 500 may include receiving a trivia game name via the template. For example, the method 500 may receive the trivia game name via one of the one of more input controls.

At 510, the method 500 may include generating an original trivia game based on the user input to the template. For example, the method 500 may include compiling the user-selected settings and responses to the input controls into a data packet that may be executed as part of a user interface that interactively displays the original trivia game.

At 512, the method 500 may include generating game cover art using an AI text-to-image generator. The AI text-to-image generator is configured for generating original game cover art based on a text prompt provided by the user. Briefly, the method 500 may include displaying an interface wherein the user may input a text-based prompt for the AI text-to-image cover art generator. In response to the user providing the prompt, the method 500 may include generating an original image using natural language, and displaying the original image. A method for using an Al text-to-image generator is shown in detail in FIG. 7. An example interface for inputting a prompt to an AI text-to-image generator is shown in FIG. 10.

At 514, the method 500 may include tagging the game with one or more game tags based on the user input to the template. In some examples, one or more site administrators may select game tags for user-generated games. In other examples, additionally, or alternatively, the user may select the game tags.

At 516, the method 500 may include receiving user confirmation to save. For example, the method 500 may include displaying a button, icon, or other mechanism via the interface which the user may click to save the game. From 516, the method 500 may continue to 522 and 526.

At 522, in response to receiving the user confirmation to save, the method 500 may include storing the original trivia game, the game name, the game cover art, and the one or more game tags in a database. For example, the original trivia game and other game metadata may be stored in a database of a user interest system, such as user interest system 140 shown in FIG. 1A and FIG. 2B. In one example, the user-selected settings may be stored in one or more indexes shown in FIG. 1B, such as game index 194. In one example, the game cover may be displayed for advertising the user-generated game. In one example, the game cover may be stored in one or more of game index 194 and art index 197 shown in FIG. 1B. The method 500 may proceed to 524.

At 524, the method 500 may include generating a game catalogue application programming interface (API). In one example, the game catalogue API provides access to a collection or database of games and related information, allowing administrators and users of a social platform, such as the social platform 1-2, to interact with the game catalogue and retrieve details about the games. The game catalogue API may allow game suggestion algorithms to push/suggest games based on user preferences and playing history. One example of a game catalogue API is shown in FIG. 9E.

Returning to 526, the method 500 may include populating a game catalogue. An example game catalogue is shown in FIG. 12. In one example, the game catalogue and/or related information may be stored in one or more indexes shown in FIG. 1B, such as game index 194.

The method 500 supports a user-friendly UI for populating a database of user-generated games with user-generated metadata such as title, description, and cover art, and in this way, enables generating and sharing personalized entertainment on the social platform. In some examples, the users may share user-generated games and share game results using SMS, email, and in some cases share within the social platform. A full-service, game creation ecosystem, such as disclosed herein, based on templates and user input is not found in existing gaming platforms. Further, game tags are conventionally created by a game developer. However, the disclosed approach provides simple user inputs and leverages AI to generate cover art, which may be used as data point stores on the social platform.

Turning to FIG. 6, an example method 600 for creating a fantasy sports league is shown. The method 600 may enable creating a fantasy sports league, such as a fantasy football team, quickly and without player knowledge in a simpler to use user interface than existing gaming platforms. In one example, the method 600 may be stored in non-transitory memory of a computing system implementing a social platform, such as computing system 180, and one or more, or all, of the steps of the method 600 may be automatically executed by the social platform, or by one or more subcomponents, modules, databases, or subsystems of the social platform. In one example, the method 600 may be executed as part of a league creator system, such as the league creator 148 described with reference to FIG. 1A. Actions illustrated in the method 600 include server side actions and client side actions, which are separated by dashed lines.

At 601, the method 600 may include displaying a fantasy league creation interface. In one example, the fantasy league creation interface may be accessed via the social platform. One example of an interface is shown in FIGS. 11A-11C. The fantasy league creation interface may display a plurality of inputs controls that enable a user to create one or more fantasy leagues, create one or more fantasy teams within various leagues, as well as socially engage with other fantasy league creators and players, and track teams and leagues throughout a league season.

At 602, the method 600 may include determining a user selection of a sport to build a fantasy league for. For example, the sport may be football. However, other sports and other fantasy leagues are imagined. As one example, in addition to selecting football as the sport, professional football or college football may be selected. The selection may be determined in response to a user selecting the sport and/or the league using via graphical user interface.

At 604, the method 600 may include suggesting a top five players at five positions. As one example, suggesting the top five players may enable one-click startup where users may quickly and easily create a fantasy sports league with minimal effort and expertise. In one example, the top five players may be displayed via an easily selectable drop down menu. Similarly, as another example, the method 600 may include suggesting a top five teams for fast and one-click startup. The number of players and/or teams, and positions suggested may vary based on the league, game settings, or other reasons. For example, the method 600 may include automatically suggesting a league comprising a plurality of players at a plurality of positions. In one example, the method 600 may include generating a roster of the top twenty-five players each week as predicted by projected fantasy points from a reputable sports data provider. For example, the top players and/or teams may be populated based on data provided in communication with a server. For example, at 626, the method 600 may load sports data that is collected live and retrieved by server logic via an API. In one example, the sports data may be stored in one or more indexes shown in FIG. 1B, such as game index 194. An example of a GUI displaying a plurality of players at a plurality of positions is shown in FIG. 11A.

At 606, the method 600 may include determining a league name and original artwork for the league based on user input using an artificial intelligence (AI) text-to-image generator. The method 600 may be similar to the approach described above with reference to the method 500 of FIG. 5, including displaying an interface wherein the user may input the league name, and input a text-based prompt for the AI text-to-image cover art generator. In response to the user providing the prompt, the method 600 may include generating and displaying original AI generated cover art. The user may confirm selection of the generated art by clicking a button. Additionally, or alternatively, the user may modify the prompt and request a new image. A graphical user interface showing prompts for generating cover art for a fantasy sports team is shown in FIG. 11A. An example method for an AI text-to-image generator is shown in FIG. 7.

At 608, the method 600 may include determining whether the user has an account on the social platform, such as the social platform 102. For example, the method 600 may include generating a prompt wherein the user may input their account information.

At 609 the method 600 may determine if a user has an account or if the user is logged into their account. In response to determining the user does not have an account, or the user is not logged into their account, at 609 (e.g., 609 is NO), the method 600 may include sending the user to a sign in/up screen. The user may be prompted to sign in or create an account. From 609, the method 600 may include returning to 608. In some example, the method 600 may further include age filtering for site entry. For example, the method 600 may include filters which verify whether a user is above an age threshold for generating some content. As another example, the method 600 may further include geolocation filtering which verify whether a user is within (or not within) a geographic region for generating some content.

At 610, the method 600 may include roster customization. In one example, the method 600 may include displaying a roster customization interface. In one example, the roster customization interface may comprise the plurality of players at the plurality of positions organized by position and in-game cost. In one example, the plurality of players may be ranked based on the sports data. Roster customization is designed to be fast and easy. For example, the roster customization may include a pre-populated league of twenty-five players organized by name and position for fast roster selection. For example, the roster may include the top five players at five positions suggested at 604. By setting the selection to five players at different positions, a league creator (e.g., a platform user) is able to make a grid within minutes for the other members of the league to choose from. In some examples, the creator (e.g., user) may also choose from a series of pre-populated grids and change players with a simple click and scroll of the player pool. For example, players and relevant statistics may be presented to the user via an easily selectable drop down menu. An example of a GUI displaying a roster customization interface is shown in FIG. 11B.

At 612, the method 600 may include updating a user budget with each player selection. For example, the user may select a player to add to a custom team, and in response to the player selection, the user budget may be adjusted based on the in-game cost to draft the player. While selecting players, the fantasy league creation interface may display a full view of the roster. In an example, the user budget is an in-game feature that may guide roster decisions of the creator. In another example, the user budget may not relate to any real or additional currency used on the platform.

At 614, the method 600 may include activating a “save team” button after picking the players for all positions within the user budget. As used herein, a button may refer to any type of user input that provides a user a mechanism to select, confirm, or otherwise indicate a choice. In an example, the “save team” button may be activated upon user selection of one player per position, e.g., five positions. The user may click the “save team button” to create a custom team for the fantasy league based on the selected players.

At 616, the method 600 may include a prediction for determining a tie breaker, referred to herein as a tie breaking prediction. As an example, the method 600 may include displaying a tic breaker prediction interface that is configured to receive a score prediction of one or more games in which the fantasy league will play. One or more players in the league may access the tie breaker prediction interface and input a prediction. In another example, based on a game outcome, a winner may be determined and points (e.g., rewards) may be awarded. For example, looking briefly to FIG. 15, an exemplary GUI for determining a tie breaker 1500 is shown. As seen at FIG. 15, the GUI for determining the tie breaker 1500 comprises a tie breaker prediction field 1502. The tic breaker prediction field 1502 is configured to allow a user to input a prediction to be used as a tie breaker. In some examples, the user may be prompted to enter a numerical value into the tie breaker prediction field 1502 based on a prompt, such as prompt 1502. For example, the user may be prompted to enter a prediction guessing a total of the score of one or more games, and the one or more games may be listed, such as shown at game list 1506. Thus, in a case where there are multiple games, the total score is a sum of the multiple games. In other examples, user may be prompted to enter a different prediction. For example, the prediction may be a non-numerical prediction, such as a prediction as to which player will be the highest scoring player. Further options for determining a tie breaker are possible without departing from the scope of the present disclosure.

In some examples, the tie breaker winner may be the user closest to the total score without exceeding the score. In such examples, if all guesses are greater than the total score, then the user closest to the total score would be the winner. Alternatively, the tie breaker winner may be the user closest to the total score without guessing less than the total score. In such alternative examples, if all the guesses are less than the total score, then the user closest to the total score would be the winner. In still other examples, alternative tie breaker rules are possible without departing from the scope of the present disclosure.

It is noted that the GUI for the prediction to determine the tie breaker 1500 may be displayed prior to displaying an all set GUI, such as shown at 1130 of FIG. 11B.

Turning back now to FIG. 6, at 617 the method may include prompting the user to invite friends to the fantasy football league using a share feature. In one example, the method may include displaying an interface wherein the user may select friends, confirm the selection, and in response, the method may include generating and sending digital invitations to one or more invitees to join the league. In one example, the share feature may comprise a native OS share model. An example graphical user interface for sharing user-generated fantasy teams with other users of a social platform is shown in FIG. 11C at GUI 1150.

At 618, the method 600 may include displaying the league in a dashboard, along with other leagues the user has made and/or joined. An example GUI displaying a dashboard is shown in FIGS. 11C. The leagues the user has made and/or joined may be stored in a database in communication with a server. For example, at 628, league data may be stored in one or more database, along with awarded league points, competition entrants, and league metadata. In one example, the league data may be stored in one or more indexes shown in FIG. 1B, such as game index 194,

At 622, the method may include enabling editing access via an edit button. Once the game is live, the editing access may be disabled.

At 624, the method may include enabling viewing a roster of an invitee once the invitee creates a league. For example, the method may include displaying a button or other feature which the user can click to view the roster of an invitee. An example graphical user interface for viewing the roster of an invitee is shown in FIG. 11C.

In this way, the disclosed approach illustrated by the method 600 simplifies fantasy league creation over existing methods. For example, by generating a roster of the top twenty-five players each single week as predicted by projected fantasy points from a reputable sports data provider, users may easily create a fantasy league without any prior knowledge of the game. For users with more expertise, the experienced users can quickly swap out players and customize their game by using a dropdown menu with projected points of the available players for the position selected. In one example, with the disclosed approach, the league creator may choose a player pool based on the 52 man rosters of the 32 NFL teams. As such, unlike other fantasy league creation approaches, there is no extensive draft process where each member of the league chooses players over several rounds of player picks. The members simply select the players they want and submit the team. Such an approach may turn a previously arduous, manual process into a process that takes a matter of minutes. The approach may include providing timely notifications to users prior to game start if an event requires them to update their roster (e.g., a player out due to injury). Further, the system may update user throughout games with the live scores of their team(s).

Turning to FIG. 7, an example method 700 for creating user-generated art is shown. In one example, the method 700 may enable a user to generate original game cover art allowing for a level of customization that is not available in existing gaming platforms. In one example, the method 700 may be stored in non-transitory memory of a computing system implementing a social platform, such as computing system 180, and one or more, or all, of the steps of the method 700 may be automatically executed by the social platform, or by one or more subcomponents, modules, databases, or subsystems of the social platform. In one example, the method 700 may be executed as part of an image generator system, such as image generator 149 described with reference to FIG. 1A. Actions illustrated in the method 700 include server side actions and client side actions, which are separated by dashed lines.

At 702, the method 700 may include presenting an input to collect a prompt for a generative artificial intelligence system. For example, a text box may be displayed to which a user may input a text prompt. An example graphical user interface presenting an input to collect a prompt for a generative artificial intelligence system is shown in FIG. 12.

At 704, the method 700 may include generating an image by the generative artificial intelligence system based on the prompt using natural language.

At 706, the method 700 may include displaying the generated image in the graphical user interface.

At 708, the method 700 may include determining whether an image selection is indicated. For example, the method 700 may include displaying a button that the user may click to confirm selection of the generated image, or modify the prompt to generate a new image. In one example, the user may generate an image, modify the prompt, and generate a new image, as many times as they wish until they select an image to store.

At 710, the method 700 may include storing the selected image as cover art for a game in a database of a server. For example, the cover art may be for a custom trivia game. In other examples, the cover art may be for a fantasy league, a fan club, or other interest group. Further games are possible without departing from the scope of the present disclosure.

At 712, the method 700 may include populating a game cover API. In one example, the game cover and game cover API may be stored in one or more indexes shown in FIG. 1B.

In this way, the disclosed approach illustrated by the method 700 enables a level of entertainment personalization not available in other gaming platforms. By using AI image generation to facilitate the game cover creation process, game covers may be designed that are appropriate for the subject matter of the game, capable of almost unlimited personalization based on user prompts, and generated without file upload from user devices.

Turning now to FIG. 8, example graphical user interfaces (GUI) 800, 810, 820, 830, 840 are shown. GUI 800, 810, 820, 830, 840 may be displayed by a social platform to a user via a display of a user computing system as part of one or more methods herein disclosed. In particular, GUI 800, 810, 820, 830, 840 comprise interfaces that may enable a user to customize an avatar 802 on the social platform.

GUI 800 displays the avatar 802 and icons 808 on a screen 801. The icons 808 may be selected by the user for navigating customization options for the avatar 802. GUI 800 shows the avatar 802 wearing a plurality of avatar wearables 804 including one or more of an expression, clothing, shoes, a hat, etc., which the user has selected for customizing the avatar 802. GUI 800 further displays a color customizer 814 including a color bar 832 and a tint panel 833, which the user may control to customize the color of the avatar 802 and/or the avatar wearables 804. The color bar 832 may be adjusted to select a color, and the tint panel 833 may be adjusted to increase or decrease tint of the color selected with the color bar, e.g., lighten or darken. In one example, in response to the user clicking on a first icon 816, e.g., a dropper, GUI 800 may display the color customizer 814.

GUI 810 shows the avatar 802 and a plurality of expressions 812, e.g., eyes, mouths, from which the user may select for personalizing the avatar 802. In one example, in response to the user clicking on a second icon 818, e.g., a face, GUI 810 may display the plurality of expressions 812. In one example, the user may click on an expression of the plurality of expressions 812. In response, GUI 810 displays the selected expression on the avatar 802.

GUI 820 shows the avatar 802 and a plurality of backgrounds 834, e.g., night sky, neighborhood, outer space, etc., that may be applied to the avatar 802. In one example, in response to the user clicking on a third icon 822, e.g., a house, GUI 820 may display the plurality of backgrounds 834. In one example, the user may click on a background of the plurality of backgrounds 834. In response, GUI 820 displays the selected background on the avatar 802.

GUI 830 shows the avatar 802 and a plurality of clothing options 826, e.g., pants, shirts, etc., that may be selected for customizing the avatar 802. In one example, in response to the user clicking on a fourth icon 824, e.g., pants, GUI 830 may display the plurality of clothing options 826. In one example, the user may click on a clothing option of the plurality of clothing options 826. In response, GUI 830 displays the selected clothing option on the avatar 802. In some examples, avatar wearables may be customized based on a brand. For example, an avatar affiliated with a brand may be customized with one or more avatar wearables 804 that promote a brand event, a product, logo, message, or other creative and/or marketing content.

GUI 840 shows the screen 801 cleared of icons 808 for a clear view of avatar 802. In some example, GUI 800, 810, 820, 830, 840 may include a randomize button 846, which the user may hit to generate and display a random selection of avatar wearables. In some examples, the user may hit a set button 844 to update the avatar 802 according to the selected and/or randomized clothing options.

In some examples, GUI 800, 810, 820, 830, 840 may include a promotion window that may be populated by one or more merchants, businesses, sponsors, etc. affiliated with the social platform. An example promotion window 806 is shown on GUI 840, for example. GUI 840 includes a shirt maker workshop link 807, which in some examples may include further customization options such as free-drawn avatar wearables, AI-assisted personalized avatar wearables, or other more advanced customization options.

Turning now to FIGS. 9A-E, example Control Panel (C-Panel) interfaces 900, 910, 920, 930, and an application programming interface (API) 950 are shown. In one example, C-panel interfaces 900, 910 may be administrator portals wherein platform administrators may create tags that administrators may use to categorize user-generated content. In one example, C-panel interfaces 920, 930 may be administrator portals wherein platform administrators may create and modify metadata associated with user-generated content. In some examples, platform users, such as merchants, brands, and businesses affiliated with the social platform, may also create and select tags for categorizing user-generated content. In one example, API 950 may be created by a site administrator based on user-generated content. C-panel interfaces 900, 910, 920, 930, and API 950 may be displayed via a display of a computing system as part of one or more methods herein disclosed. In particular, C-panel interfaces 900, 910, 920, 930 comprise interfaces that may enable a categorization system that tags games thereby allowing for precise and efficient game suggestion algorithms and content delivery.

FIG. 9A shows the C-panel interface 900, including a plurality of tags arranged in rows 901 and associated metadata arranged in a plurality of columns 902 including an action column, a tag name column, a parent column, a status column, a creation time column, an update time column, and an add button 904 displayed on a screen 905. The name column includes a tag name corresponding to each tag arranged in the plurality of rows 901. In the example, “sports” is the name of the tag in the first row. The parent column may include categories that the tag may be sorted into. For example, the football tag may be included in the sports category. The administrator may edit or delete a tag by clicking the corresponding icon in the action column. The action status column may be updated to reflect the status of the tag. The time that a tag is created may be displayed in the creation time column and the time that a tag is updated may be displayed in the update time column. The administrator may hit the add button 904 to enter a tag creation interface. In some examples, the inputs are used by administrators to create separation of ideas on the user interface so users can quickly categorize games visually.

FIG. 9B shows the C-panel interface 910, illustrating an example of backend handling of tag data. For example, in response to the administrator hitting the update icon in the action column in FIG. 9A, the C-panel interface 910 may be displayed. C-panel interface 910 includes a name bar 912, a parent bar 914, an activation button 916, an update button 918, and a back button 919. The administrator may update the name of the tag in the name bar 912, and update the category in the parent bar 914. The administrator may deactivate or activate the tag with the activation button 916. The administrator may save the settings by hitting the update button 918, and return to the C-panel interface 900 by hitting the back button 919. By creating a robust library of tags and content, the user experience may be enriched.

FIG. 9C shows the C-panel interface 920, illustrating a first example of backend handling of metadata associated with a user-generated game. For example, in response to a user creating a new game, the metadata associated with the user-generated game may populate the C-panel interface 920. Further, one or more site administrators may modify or update the metadata that populates the C-panel interface 920. In the example, the C-panel interface 920 displays a plurality of metadata inputs 922 including platform version, game title, subtitle, game type, creator, game URL, and game description. The C-panel interface displays a plurality of image inputs 924, where one or more images associated with the user-generated game may be stored.

FIG. 9D shows the C-panel interface 930, illustrating a second example of backend handling of metadata associated with a user-generated game. For example, in response to a user creating a new game, a site administrator may assign the new game to one or more collections and assign one or more tags to the game. A plurality of collections 932 are displayed on the C-panel interface 930, such as, for example, explore, playoffs, entertainment, and so on. Similarly, a plurality of tags 934 are displayed including, for example, sports, quotes, trivia, and so on. The C-panel interface 930 may include a sort bar 938 for sorting one or both of the plurality of collections 932 and the plurality of tags 934. The C-panel interface 930 may further display one or more images 936 associated with the user-generated game. The C-panel interface 930 may include an update button 940 which the administrator or other user may click to update the metadata associated with the user-generated game, and a back button 942 which may be clicked to return to a prior C-panel interface.

FIG. 9E shows the API 950, which is an example game catalogue API for a user-generated game. API 950 may be created by platform administrators, and accessed by the social platform to allow interaction between users of the social platform and the social platform. In one example, the game catalogue API may enable platform users and platform administrators to efficiently navigate a user-generated game catalogue.

Turning now to FIG. 10, example graphical user interfaces (GUI) 1000, 1010, 1020, 1030, 1040 are shown. GUI 1000, 1010, 1020, 1030, 1040 may be displayed by a social platform to a user via a display of a user computing system as part of one or more methods herein disclosed. In particular, GUI 1000, 1010, 1020, 1030, 1040 may comprise a sequence of interfaces of a game creation module that enable the user to create an original game on the social platform. In one example, the original game may be created according to the methods disclosed herein, such as the method 500 in FIG. 5. GUI 1000, 1010, 1020, 1030, 1040 illustrate a module for creating a trivia game by way of example only. It should be understood that users may interact with a similar sequence of interfaces for creating other types of games, such as a lottery, spelling bee, word scramble, and so on.

GUI 1000 shows a start page that a platform user may view and interact with when creating a new game. GUI 1000 displays a landing page 1002 of the game creation module including a title, e.g., my trivia, a description, e.g., for creating custom trivia, and an associated image, and a start button 1003 displayed on a screen 1001. The user may click the start button 1003 to initiate creation of a custom trivia game.

GUI 1010 displays instructions 1004 and a confirmation button 1006. The user may click the confirmation button 1006 to view the next GUI in the sequence of the game creation module.

GUI 1020 displays a first portion 1008 of a template including a first input where the user may select a question type, e.g., multiple choice quiz, true/false quiz, etc., a second input where the user may set a time threshold, e.g., 15 seconds, no threshold, etc., and a next button 1012. The user may click the next button 1012 to view the next GUI in the sequence of the game creation module.

GUI 1030 displays a second portion 1014 of the template including a question input where the user may input a first custom question, and a plurality of answer inputs. For example, a multiple choice game GUI may include a first answer input where the user may input a correct response, and one or more additional answer inputs where the user may input one or more incorrect answers, and a true/false game, GUI may include a second answer input for a true answer and a third answer input for a false answer. The GUI 1030 displays a next question button 1016 and a finish button 1018. For example, the user may click the next question button 1016 and in response GUI 1030 may be presented again to the user to create a second custom question. When the user is finished creating questions, the user may click the finish button 1018 to view a game details template.

GUI 1040 shows an example of a game details template including a name input 1022, a cover art input 1024, a generate button 1026, a game cover panel 1028, and a finish button 1032. In one example, a user may input a name into the name input 1022. The user may input a text prompt into the cover art input 1024. The user may submit the text prompt to an AI text-to-image generator upon clicking the generate button 1026. In response, the AI text-to-image generator may generate custom cover art for a game based on the text prompt, such as according to one or both of the method 500 described with reference to FIG. 5, and the method 700 described with reference to FIG. 7. The AI text-to-image generator may display the game cover and the user-generated name in the game cover panel 1028. The user may indicate they are satisfied with the game name and cover art by clicking the finish button 1032. In one example, the system may compile the user-selected settings and responses to the input controls into a data packet that may be executed as part of a game play interface that interactively displays the original trivia game. One example of a game play interface is shown below in FIG. 13. The system may store the user-generated game, game name, cover art, and associated metadata with the user-generated game.

Turning now to FIGS. 11A-C, example graphical user interfaces (GUI) 1100, 1110, 1120, 1130, 1140, 1150, 1160, 1170 are shown. GUI 1100, 1110, 1120, 1130, 1140, 1150, 1160, 1170 may be displayed by a social platform to a user via a display of a user computing system as part of one or more methods herein disclosed. In particular, GUI 1100, 1110, 1120, 1130, 1140, 1150, 1160, 1170 comprise interfaces that may enable a user to create a fantasy league team on a social platform, such as the social platform 102. In one example, the fantasy league team may be created according to the methods disclosed herein, such as the method 600 in FIG. 6. FIGS. 11A-11C show examples wherein a fantasy football team is created on a social platform; however, it may be understood that a similar approach may be applied to multiple sports beyond football, as well as other interests beyond sports, such as live competitions, e.g., cooking, modeling, dog shows, and awards shows.

GUI 1100 shows an example league customization page. In one example, the league customization page may be populated with an automatic suggestion of a league including a plurality of players 1102 at a plurality of positions 1104 for one-click startup, such as described above with reference to the method 600. In the example, the league customization page includes a suggested five players at five positions.

GUI 1170 displays a league cover template 1154 that enables a user to generate original cover art for a fantasy league using an Al text-to-image generator. In one example, the user may be directed to the league cover template during fantasy league creation, such as described above with reference to the method 600. For example, the league cover template 1154 includes a name input 1156, a league cover input 1158, a generate button 1162, a league cover panel 1164, and a confirmation button 1166. In one example, the user may input a custom league name into the name input 1156. The user may input a text prompt into the league cover input 1158. The user may submit the text prompt to an AI text-to-image generator upon clicking the generate button 1162. In response, the AI text-to-image generator may generate original, custom cover art for the fantasy league based on the text prompt. The AI text-to-image generator may display the league cover and the name in the league cover panel 1164. The user may indicate they are satisfied with the league name and cover art by clicking the confirmation button 1166. In response, the system may store the user-generated fantasy league, fantasy league name, fantasy league cover art, and associated metadata with the user-generated fantasy league.

GUI 1180 shows an example of a sign in/up screen of a social platform. In one example, the user may be directed to the sign in/up screen during fantasy league creation, such as described above with reference to the method 600. In one example, the user may be directed to the sign in/up screen in response to the social platform being unable to determine whether the user has an account, such as one of accounts 120 in FIG. 1A. GUI 1180 includes a plurality of account access links 1182, e.g., to web applications, an account input 1184, and an enable button 1186 on a screen 1101. The user may enter an account name and password into the account input 1184, and hit the enable button 1186 to submit the account input 1184. In some examples, the sign in/up screen may further include filtering for age and/or geolocation, as described above with reference to the method 600. Additionally, or alternatively, the user may be invited to the social platform via a link sent in an SMS or email, and in response to clicking on the link, the user may be directed to the GUI 1180.

GUI 1110 displays an example of a roster customization interface for fast and easy roster customization. GUI 1110 includes a remaining budget 1108, a player salary bar 1112, and the plurality of players 1102 at the plurality of positions 1104. In the example, GUI 1110 displays the top five of players at each of five positions, such as the top five running backs, wide receivers, and so on, based on player performance statistics. In an example, the plurality of players 1102 are ranked or ordered according to a salary shown on the player salary bar 1112. The remaining budget 1108 is automatically calculated based on players selected and their respective salary. In other words, the player salary bar 1112 displays an in-game cost of adding a player 1114 to a custom team, and the in-game cost may be used for updating the remaining budget. Selecting among the top five players from the plurality of positions 1104 may enable fast and easy team creation with lower barrier to entry than existing fantasy league creation platforms. The user may hit a save roster button 1118 to save the selected roster of player.

GUI 1120 displays an example of individual player information that may be displayed as part of the roster customization interface. GUI 1120 includes a player salary 1122 listed above an image 1125 of a selected player 1124 and a save button 1128. Comparable players 1126 may be shown below the selected player 1124. GUI 1120 may display a plurality of descriptions 1127, such as player fantasy points (PFP), name, team, number etc., pertaining to the selected player 1124 and the comparable players 1126 for quick and easy comparison. The user may hit the save button 1128 to save the selected player 1124 to a customized roster.

GUI 1130 displays an example of a customized roster 1132 or lineup. The customized roster 1132 may include a selected player 1124 at each position 1116 of the team, e.g., five players, and a next button 1134. The user may hit the next button 1134 to view a fantasy user dashboard.

GUI 1140 displays an example of a fantasy user dashboard 1136. The fantasy user dashboard 1136 may show a schedule 1138, a fantasy league 1142, the customized roster 1132 of the user for the fantasy league 1142, and a share feature 1144 for further customization and social interaction, such as inviting friends to the fantasy league 1142.

GUI 1150 displays the fantasy user dashboard 1136 with the share feature 1144 selected. With the share feature 1144 selected, one or more friends 1146 are displayed that the user has invited to the fantasy league 1142. The user may click the share 1144 to invite more friends. Invite status of each friend, e.g., accepted, waiting, may also be displayed. The share feature 1144 may be accessed within other GUIs that are displayed as part of other modules of the social platform, such as within the game creator module, and to share results of games or competitions.

GUI 1160 displays an example of the fantasy user dashboard 1136 during a live game 1149 for the fantasy league 1142. The GUI 1160 shows one or more friends 1146, and plurality of fantasy rosters 1148 and a plurality of fantasy league scores 1152 associated with the friends 1146.

Turning now to FIG. 12, example graphical user interface (GUI) 1200, 1220, 1230, 1240, 1250 are shown. GUI 1200, 1220, 1230, 1240, 1250 may be displayed by a social platform to a user via a display of a user computing system as part of one or more methods herein disclosed. In particular, GUI 1200, 1220, 1230, 1240, 1250 may be one example of a user account displaying personalized entertainment affiliated with a user, such as user account 122 affiliated with one of users 104, 106, 108 in FIG. 1A. GUI 1200, 1220, 1230, 1240, 1250 may display one or more or all of user interests, user marketplaces, user rewards, user transactions, and/or other customized entertainment content that may be developed and accessed via a social platform, such as the social platform 102.

GUI 1200 is displayed on a screen 1201 including an avatar 1202, a navigation bar 1203, an interests panel 1204, an activity panel 1208, and an invitation panel 1212. The avatar 1202 may be personalized via the approaches disclosed herein, such as avatar creator 142 in FIG. 1A and the method 300 in FIG. 3. The navigation bar 1203 includes tabs which may be selected to navigate to other interfaces or modules comprising the social platform. For example, a game catalog may be viewed by selecting a play tab 1205, a maker catalog may be viewed by selecting a create tab 1207, and GUI 1200 may be viewed by selecting a home tab 1209. In some examples, the user may provide feedback directly to the social platform by selecting the home tab 1209. For example, the home tab 1209 may display a link to a help desk where issues may be reported to one or more administrators.

The interests panel 1204 may display a plurality of personalized interests 1206, such as user-generated games, fantasy leagues, art, and so on. The activity panel 1208 may display a plurality of activities 1210 of the user, such as games and fantasy leagues, based on most-recently played, most-frequently played, and/or game tags. In some examples, the activity panel 1208 may include a game playground or a link to a game playground, where recently played games, creations, and other user interests are displayed. The invitation panel 1212 may display one or more invitations 1214 to play games, activities, join groups, etc., via the social platform. In one example, the plurality of personalized interests 1206 and the plurality of activities 1210 may be accessed through GUI 1200 and played directly through the social platform and in doing so the user may accumulate user rewards, such as user rewards 132 for the fantasy league in FIG. 1A. User rewards may be displayed in as a bank 1216 including platform-based currency 1218.

GUI 1220 displays an example of a game catalog 1222 including a plurality of games 1224. The user may select a game 1224 to play via the social platform. In some examples, the game catalog 1222 may display challenges and competitions that the user may join to collect rewards, such as the platform-based currency 1218.

GUI 1230 displays an example of a maker catalog 1232 including a plurality of maker templates 1234. In one example, the user may view and use game creation tools in the maker catalog 1232 by selecting the create tab 1207 displayed in GUI 1200. The plurality of maker templates 1234 may be accessed by the user to create the plurality of personalized interests 1206. In one example, the plurality of maker templates 1234 may include built-in tools to enable the user to create original games within the social platform. In some examples, the plurality of maker templates 1234 offer the user the ability to create a game with game name, game cover, game description, game tags, hints, and game challenges. In some examples, users may not be able to edit games once the creation process is carried out. In some examples, users may share the custom content with friends or delete the custom content.

GUI 1240 displays an example of a friend panel 1242. The friend panel 1242 may display one or more other platform users 1244 who have accounts linked to the account of the user on the social platform. In some examples, the user may view and use game creation tools in the maker catalog by selecting the create tab 1207.

GUI 1250 displays an example of an interest panel 1252. The interest panel 1252 display a plurality of interests 1254. In some examples, the user may select one or more interests of the plurality of interests 1254 and submit the selection to be stored with user account data by clicking a finished button 1256. In one example, the selected interests may be used in a suggestion algorithm. For example, the selected interests may be used by one or more of a game suggestion algorithm, a personalized marketplace generation algorithm, or other personalized entertainment suggestion algorithm on the social platform.

Turning now to FIG. 13, an example graphical user interface (GUI) 1300 is shown. GUI 1300 may be displayed by a social platform to a user via a display of a user computing system as part of one or more methods herein disclosed. In particular, GUI 1300 may be one example of an interface or module for sharing a multiplayer game. In one example, GUI 1300 may enable users to share original games and activities with other platform users and to invite other platform users to compete against the user in games and other activities on the social platform.

GUI 1300 displays a selected game 1302, at least one player 1304 (e.g., the user), an invitation button 1306, and a play button 1308 on a screen 1301. The user may click the invitation button 1306 to invite additional players to play in a multiplayer game. The user may click the play button 1308 to proceed to play the selected game 1302.

GUI 1310 displays a friend panel 1312, a plurality of friends 1314, and a plurality of send buttons 1316 corresponding to each friend. The user may click on a send button to send an invitation to the corresponding friend.

GUI 1320 displays a multiplayer loading panel 1322 for the selected game 1302, including a plurality of competitors 1334, the invitation button 1306, and the play button 1308. The user may add additional competitors by clicking the invitation button 1306, or may proceed to play a multiplayer game with competitors who have accepted the invitation by clicking the play button 1308.

GUI 1330 displays a game play interface 1332 for the selected game 1302, including an input 1336. The user and competitors may view the game play interface 1332, and interact with each other via the input 1336 during multiplayer game play. GUI 1330 shows a word game by way of example only. However, it should be understood that other game boards and other inputs may be displayed during multiplayer game play.

GUI 1340 displays a multiplayer game results panel 1342 for the selected game 1302, including the plurality competitors 1334 ranked by scores, a rematch button 1346, and a share button 1348. The user may click the rematch button 1346 to invite the plurality of competitors 1334 to play again, and click the share button 1348 to share the results of the game via the social platform.

GUI 1350 displays a certificate 1354 with the name of the winner, the game won, associated imagery, or other features, the share button 1348, and an again button 1356. The user may click the click the share button 1348 to share the game results panel with other platform users via the social platform. For example, in response to clicking the share button 1348, the GUI 1310 (or similar) may be displayed. With the GUI 1310 displayed, the user may click the send button to share the certificate 1354 with the corresponding friend via the social platform. In one example, in response to clicking the again button 1356, the GUI displays, or returns to, a create page that enables a user to make a new prediction, or other user interest.

GUI 1360 displays, in some examples, an SMS share panel 1362 including a plurality of contacts 1364 stored on a mobile device of the user. The user may select one or more of the plurality of contacts 1364 to share the certificate 1354 through a mobile application 1376, e.g., SMS.

GUI 1370 displays the certificate 1354 as it would appear on the device of the receiving user.

Turning now to FIG. 14, an example graphical user interface (GUI) 1400, 1420 is shown. GUI 1400, 1420 may be displayed by a social platform to a user via a display of a user computing system as part of one or more methods herein disclosed. In particular, GUI 1400 may be one example of a marketplace displaying products and entertainment content affiliated with a merchant, such as marketplace 204 affiliated with merchant 110 in FIG. 2A. In an example, platform users may visit GUI 1400 where products, experiences, promotional content, and other entertainment content are displayed by the affiliated merchant. In this or another example, GUI 1400 may be a marketplace representing a brand.

GUI 1400, 1420 displays a brand panel 1402, a website link 1404, a brand game panel 1406, a products panel 1408, and a favorites panel 1410. For example, the merchant may display one or more images 1416, such as a logo, or other creative content, on the brand panel 1402. A platform user may connect to an external webpage, for example owned by the merchant, via the website link 1404. The brand game panel 1406 may display one or more games 1412, such as games sponsored and/or created by the merchant. The products panel 1408 may display one or more products 1414. The products 1414 may be custom creative content, such as advertisements, webpages, videos, experiences, digital environments, fan groups, and so on. In some examples, products 1414 may include real goods and/or digital items that are available for purchase. The favorites panel 1410 may display a plurality of content 1418 owned or created by other brands, other users, etc., that the brand has indicated an affiliation with. In some examples, GUI 1400, 1420 may include a friend panel (not shown) displaying one or more other platform users who have accounts linked to the merchant affiliated with GUI 1400.

In this way, a social platform may appeal to broad range of users from experienced gamers to novices. Simple and efficient graphical user interfaces and complementary server-side interfaces allow platform users to personalize entertainment content, generate new content, and share personalized entertainment content among platform users with like interests. By encouraging entertainment customization, and incentivizing interaction with the social platform via user rewards and personalized marketplaces, opportunities to engage outside merchants and potential sponsors of the gaming platform with valuable user preference information are increased.

The disclosure also provides support for a computer-implemented method comprising: providing a user interface by a social platform to generate personalized entertainment content, the social platform comprising a plurality of user accounts, a user interest system, and a marketplace system, the user interest system comprising one or more modules configured to present a plurality of input controls for generating one or more user interests by the social platform, receiving user input from a user associated with a user account via the plurality of input controls, generating a user interest based on the user input, storing the user interest in a database, and displaying the user interest on the social platform. In a first example of the method, the one or more user interests comprise user-generated content that is displayed and accessed via the user account. In a second example of the method, optionally including the first example, the one or more user interests comprise one or more of an original game, a fantasy sports league, a custom avatar, trophies, badges, last-played game, most-played games, game catalogues, social connections, affiliations, and brands. In a third example of the method, optionally including one or both of the first and second examples, the user interest system comprises a maker template, the maker template configured for generating an original game by the social platform based on a template and user input to the template. In a fourth example of the method, optionally including one or more or each of the first through third examples, the original game comprises a trivia game, and wherein the template displays for user selection one or more of a quiz type, a quiz duration, and one or more input boxes to receive user-generated questions and answers. In a fifth example of the method, optionally including one or more or each of the first through fourth examples, the method further comprises: generating an original game cover based on user input to an artificial intelligence (AI) text-to-image generator. In a sixth example of the method, optionally including one or more or each of the first through fifth examples, the method further comprises: compiling user-selected settings and responses to the plurality of input controls into a data packet configured to be executed as part of a game play interface that interactively displays the trivia game. In a seventh example of the method, optionally including one or more or each of the first through sixth examples, the method further comprises: tagging the original game with one or more game tags, storing the original game and the one or more game tags in one or more databases, populating a game catalogue, and suggesting the user interest to one or more of the plurality of user accounts based on the one or more game tags. In a eighth example of the method, optionally including one or more or each of the first through seventh examples, the user interest system comprises a league creator, the league creator configured for generating a fantasy sports league by the social platform based on sports data loaded from an application programming interface (API), an automatically suggested league comprising a plurality of players at a plurality of positions based on the sports data, and user input to a roster customization interface. In a ninth example of the method, optionally including one or more or each of the first through eighth examples, the roster customization interface comprises the plurality of players at the plurality of positions organized by position and in-game cost, the roster customization interface configured to receive a user selection of one or more players, wherein the in-game cost is used for updating a user budget.

The disclosure also provides support for a system comprising: a memory comprising instructions, and one or more processors, wherein the instructions, when executed by the one or more processors, cause the system to perform operations comprising: provide a user interface by a social platform to generate personalized entertainment, the social platform comprising a plurality of user accounts, a user interest system, and a marketplace system, the user interest system comprising one or more modules configured to present a plurality of input controls for generating one or more user interests by the social platform, receive user input from a user associated with a user account via the plurality of input controls, generate a user interest based on the user input, tag the user interest with one or more tags, each tag comprising a category configured for use in a suggestion algorithm, store the user interest and the one or more tags in a database, display the user interest on the social platform, and suggest the user interest to one or more of the plurality of user accounts based on the one or more tags. In a first example of the system, the one or more modules comprises a maker template, the maker template configured for generating personalized entertainment by the social platform, and wherein the instructions further comprise: display a template for a user-generated game, receive user input to the template, generate an original game based on the user input, generate a game cover based on user input to an artificial intelligence text-to-image generator, tag the original game with one or more game tags, store the original game, the game cover, and the one or more game tags in one or more databases, populate a game catalogue, and suggest the user interest to one or more of the plurality of user accounts based on the one or more game tags. In a second example of the system, optionally including the first example, the original game comprises a user-generated trivia game, and wherein the template displays for user selection of one or more of a quiz type, a quiz duration, and one or more input boxes to receive user-generated questions and answers. In a third example of the system, optionally including one or both of the first and second examples the instructions further comprising: compile user-selected settings and responses to the plurality of input controls into a data packet configured to be executed as part of a game play interface that interactively displays the user-generated trivia game. In a fourth example of the system, optionally including one or more or each of the first through third examples, the one or more modules comprises a league creator, the league creator configured for generating a fantasy sports league by the social platform, and wherein the instructions further comprise: load sports data from an application programming interface (API), display a fantasy league creation interface, automatically suggest a league comprising a plurality of players at a plurality of positions based on the sports data, determine a fantasy league name and fantasy league cover art based on user input, display a roster customization interface, receive a user selection of one or more players, update a user budget with each player selection, generate a custom team based on the user selection, and store the fantasy sports league and the custom team in one or more databases. In a fifth example of the system, optionally including one or more or each of the first through fourth examples, the roster customization interface comprises the plurality of players at the plurality of positions organized by position and in-game cost, the roster customization interface configured to receive the user selection of one or more players, and wherein the in-game cost is used for updating the user budget. In a sixth example of the system, optionally including one or more or each of the first through fifth examples, the marketplace system comprises a plurality of user marketplaces, each user marketplace comprising a personalized marketplace of goods based on one or more user interests of the user configured for purchase via the social platform, wherein the goods comprise one or more of digital goods, physical goods, and sponsor-related products. In a seventh example of the system, optionally including one or more or each of the first through sixth examples the instructions further comprising: generate user rewards based on user interaction with the social platform, wherein the user rewards are configured for purchasing goods via the marketplace system.

The disclosure also provides support for a non-transitory machine-readable storage medium including instructions that, when executed by a machine, cause the machine to perform operations comprising: providing a user interface by a social platform to generate personalized entertainment, the social platform comprising a plurality of user accounts, a user interest system, and a marketplace system, the user interest system comprising one or more modules configured to present a plurality of input controls for generating one or more user interests by the social platform, receiving user input from a user associated with a user account via the plurality of input controls, generating a user interest based on the user input, storing the user interest in a database, tagging the user interest with one or more tags, each tag comprising a category configured for use in a suggestion algorithm, suggesting the user interest to one or more of the plurality of user accounts based on the one or more tags, and displaying the user interest on the social platform. In a first example of the system, the one or more user interests comprise one or more of an original game, a fantasy sports league, a custom avatar, trophies, badges, last-played game, most-played games, game catalogues, social connections, affiliations, and brands.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer-implemented method comprising:
providing a user interface by a social platform to generate personalized entertainment content, the social platform comprising a plurality of user accounts, a user interest system, and a marketplace system, the user interest system comprising one or more modules configured to present a plurality of input controls for generating one or more user interests by the social platform;
receiving user input from a user associated with a user account via the plurality of input controls;
generating a user interest based on the user input;
storing the user interest in a database; and
displaying the user interest on the social platform.

2. The computer-implemented method of claim 1, wherein the one or more user interests comprise user-generated content that is displayed and accessed via the user account.

3. The computer-implemented method of claim 1, wherein the one or more user interests comprise one or more of an original game, a fantasy sports league, a custom avatar, trophies, badges, last-played game, most-played games, game catalogues, social connections, affiliations, and brands.

4. The computer-implemented method of claim 1, wherein the user interest system comprises a maker template, the maker template configured for generating an original game by the social platform based on a template and user input to the template.

5. The computer-implemented method of claim 4, wherein the original game comprises a trivia game, and wherein the template displays for user selection one or more of a quiz type, a quiz duration, and one or more input boxes to receive user-generated questions and answers.

6. The computer-implemented method of claim 5, further comprising generating an original game cover based on user input to an artificial intelligence (AI) text-to-image generator.

7. The computer-implemented method of claim 6, further comprising compiling user-selected settings and responses to the plurality of input controls into a data packet configured to be executed as part of a game play interface that interactively displays the trivia game.

8. The computer-implemented method of claim 4, further comprising
tagging the original game with one or more game tags;
storing the original game and the one or more game tags in one or more databases;
populating a game catalogue; and
suggesting the user interest to one or more of the plurality of user accounts based on the one or more game tags.

9. The computer-implemented method of claim 1, wherein the user interest system comprises a league creator, the league creator configured for generating a fantasy sports league by the social platform based on sports data loaded from an application programming interface (API), an automatically suggested league comprising a plurality of players at a plurality of positions based on the sports data, and user input to a roster customization interface.

10. The computer-implemented method of claim 9, wherein the roster customization interface comprises the plurality of players at the plurality of positions organized by position and in-game cost, the roster customization interface configured to receive a user selection of one or more players, wherein the in-game cost is used for updating a user budget.

11. A system comprising:
a memory comprising instructions; and
one or more processors, wherein the instructions, when executed by the one or more processors, cause the system to perform operations comprising:
provide a user interface by a social platform to generate personalized entertainment, the social platform comprising a plurality of user accounts, a user interest system, and a marketplace system, the user interest system comprising one or more modules configured to present a plurality of input controls for generating one or more user interests by the social platform;
receive user input from a user associated with a user account via the plurality of input controls;
generate a user interest based on the user input;
tag the user interest with one or more tags, each tag comprising a category configured for use in a suggestion algorithm;
store the user interest and the one or more tags in a database;
display the user interest on the social platform; and
suggest the user interest to one or more of the plurality of user accounts based on the one or more tags.

12. The system of claim 11, wherein the one or more modules comprises a maker template, the maker template configured for generating personalized entertainment by the social platform, and wherein the instructions further comprise:
display a template for a user-generated game;
receive user input to the template;
generate an original game based on the user input;
generate a game cover based on user input to an artificial intelligence text-to-image generator;
tag the original game with one or more game tags;
store the original game, the game cover, and the one or more game tags in one or more databases;
populate a game catalogue; and
suggest the user interest to one or more of the plurality of user accounts based on the one or more game tags.

13. The system of claim 12, wherein the original game comprises a user-generated trivia game, and wherein the template displays for user selection of one or more of a quiz type, a quiz duration, and one or more input boxes to receive user-generated questions and answers.

14. The system of claim of claim 13, the instructions further comprising:
compile user-selected settings and responses to the plurality of input controls into a data packet configured to be executed as part of a game play interface that interactively displays the user-generated trivia game.

15. The system of claim 11, wherein the one or more modules comprises a league creator, the league creator configured for generating a fantasy sports league by the social platform, and wherein the instructions further comprise:
load sports data from an application programming interface (API);
display a fantasy league creation interface;
automatically suggest a league comprising a plurality of players at a plurality of positions based on the sports data;
determine a fantasy league name and fantasy league cover art based on user input;
display a roster customization interface;
receive a user selection of one or more players;
update a user budget with each player selection;
generate a custom team based on the user selection; and
store the fantasy sports league and the custom team in one or more databases.

16. The system of claim 15, wherein the roster customization interface comprises the plurality of players at the plurality of positions organized by position and in-game cost, the roster customization interface configured to receive the user selection of one or more players, and wherein the in-game cost is used for updating the user budget.

17. The system of claim 11, wherein the marketplace system comprises a plurality of user marketplaces, each user marketplace comprising a personalized marketplace of goods based on one or more user interests of the user configured for purchase via the social platform, wherein the goods comprise one or more of digital goods, physical goods, and sponsor-related products.

18. The system of claim 17, the instructions further comprising:
generate user rewards based on user interaction with the social platform, wherein the user rewards are configured for purchasing goods via the marketplace system.

19. A non-transitory machine-readable storage medium including instructions that, when executed by a machine, cause the machine to perform operations comprising:
providing a user interface by a social platform to generate personalized entertainment, the social platform comprising a plurality of user accounts, a user interest system, and a marketplace system, the user interest system comprising one or more modules configured to present a plurality of input controls for generating one or more user interests by the social platform;
receiving user input from a user associated with a user account via the plurality of input controls;
generating a user interest based on the user input;
storing the user interest in a database;
tagging the user interest with one or more tags, each tag comprising a category configured for use in a suggestion algorithm;
suggesting the user interest to one or more of the plurality of user accounts based on the one or more tags; and
displaying the user interest on the social platform.

20. The non-transitory machine-readable storage medium of claim 19, wherein the one or more user interests comprise one or more of an original game, a fantasy sports league, a custom avatar, trophies, badges, last-played game, most-played games, game catalogues, social connections, affiliations, and brands.
